(19) United States
(12) Patent Application Publication
(10) Pub. No.: US 2014/0166834 A1
(43) Pub. Date: Jun. 19, 2014

(54) BRACKET, ATTACHING SYSTEM, PAPER PATTERN, DISPLAY APPARATUS, AND TELEVISION RECEIVER

(71) Applicants: Hitoshi Kuroyanagi, Osaka-shi (JP); Kenta Moribe, Osaka-shi (JP); Tomohiro Okata, Osaka-shi (JP); Kenichiro Ito, Osaka-shi (JP); Yasufumi Gouma, Osaka-shi (JP); Hideto Takeuchi, Osaka-shi (JP)

(72) Inventors: Hitoshi Kuroyanagi, Osaka-shi (JP); Kenta Moribe, Osaka-shi (JP); Tomohiro Okata, Osaka-shi (JP); Kenichiro Ito, Osaka-shi (JP); Yasufumi Gouma, Osaka-shi (JP); Hideto Takeuchi, Osaka-shi (JP)

(73) Assignee: SHARP KABUSHIKI KAISHA, Osaka-shi, Osaka (JP)

(21) Appl. No.: 14/237,005

(22) PCT Filed: Apr. 4, 2012
(86) PCT No.: PCT/JP2012/059269

§ 371 Date: Feb. 4, 2014

(30) Foreign Application Priority Data
Aug. 23, 2011 (JP) 2011-181872
Feb. 16, 2012 (JP) 2012-032168

(51) Int. Cl. F16M 13/02

(52) U.S. Cl. CPC F16M 13/02
USPC 248/231.91; 33/563

(57) ABSTRACT

Disclosed is a bracket that allows a target object to be attached easily and prevents it from being detached unexpectedly after the attachment. A bracket (10) for attaching, to a wall surface, a television provided with locking pins (30) fixed thereto includes a back board section (11), an upper board section (13), a lower board section (15), and a front board section (14), the front board section (14) and the back board section (11) being separated from each other by a clearance that is large at an upper portion and small at a lower portion.

### TECHNICAL FIELD

The present invention relates to (i) a bracket for hanging a target object on a wall surface for attachment thereto, (ii) an attachment system including the bracket, (iii) a paper pattern for use in attaching the bracket to a wall surface, and (iv) a display device and television receiver to be hung on a wall surface for attachment thereto.

### BACKGROUND ART

Television receivers (hereinafter referred to simply as “televisions”) have been produced with increasingly smaller thicknesses in recent years. There are marketed televisions that can be placed on a wall surface (hung on a wall surface for attachment thereto). A television is placed on a wall surface by a method of placing a wall-mounting metal fitting on the wall surface for attachment of the television.

Patent Literature 1, for example, discloses a device for attaching a planar display to a wall. The device includes a pair of metal plates and rod-shaped projections. The pair of metal plates each have a cross section substantially in the shape of the character “<”, and each have (i) a base section with tapped holes and (ii) a tip section with notches that are each substantially in the shape of the character “U” and that are next to each other vertically. The rod-shaped projections are so provided at respective positions on either side surface of the planar display as to be next to each other vertically. The rod-shaped projections provided on the opposite sides are symmetrical to each other.

### CITATION LIST

Patent Literature 1
Japanese Patent Application Publication, Tokukaihei, No. 11-18022 A (Publication Date: Jan. 22, 1999)

Patent Literature 2
Japanese Patent Application Publication, Tokukai, No. 2005-341547 A (Publication Date: Dec. 8, 2005)

### SUMMARY OF INVENTION

### Technical Problem

Conventional televisions have a large body mass (for example, approximately 10 kg for a 40-inch television). Stably attaching such a television to a wall surface requires an accordingly large wall-mounting metal fitting. FIG. 21 is an example wall-mounting metal fitting for use in a conventional technique. Wall-mounting metal fittings are complicated in structure as illustrated in FIG. 21. Large-scale engineering work is necessary for attachment of such a metal fitting to a wall surface and of a television to the metal fitting. This has led to the following problem: The position of a television cannot be changed easily for rearrangement of the room or the like.

The technique of Patent Literature 1 further involves the following risk: In the case where force has been applied to the television from below in such a direction as to push up the television, that is, in the case where force has been applied in a direction along the notches each in the shape of the character “U”, the television may be lifted out of the pair of metal plates.

The present invention has been accomplished in view of the above problems. It is an object of the present invention to provide a bracket that allows a target object to be attached to a wall surface easily and that is not detached unexpectedly after the attachment.

### Solution to Problem

In order to solve the above problems, the present invention is a bracket for hanging a target object on a wall surface for attachment of the target object to the wall surface, the target object being provided with a pin attached to the target object, the bracket including: a back board section to be attached to the wall surface; and a front board section facing the back board section, the front board section having at least one guide slot extending from an upper end of the front board section in a downward direction, the back board section and the front board section being separated from each other by a clearance that is large at an upper portion and small at a lower portion so that a head section of the pin of which a neck section is fitted in the guide slot is sandwiched between the back board section and the front board section.

The bracket is structured such that the clearance between the back board section and the front board section is large at an upper portion and small at a lower portion. The head section of the pin inserted in the guide slot is, as the pin is moved downward along the guide slot, sandwiched between the back board section and the front board section to be fixed. With this arrangement, attaching a target object to a wall surface merely requires moving the pin, attached to the target object, downward along the guide slot. The above arrangement thus facilitates the attachment of a target object to a wall surface. Further, detaching a target object from a wall surface merely requires moving the target object upward along the guide slot. The above arrangement thus facilitates the detachment of a target object from a wall surface. After the attachment, the pin being sandwiched in the guide slot can prevent the target object and the wall surface from being possibly shaken relative to each other when, for instance, an earthquake occurs, thereby preventing the target object from being detached unexpectedly from the wall surface.

An attachment system of the present invention includes the bracket and the pin.

The attachment system produces effects similar to those produced by the above bracket.

A wallpaper of the present invention is a wallpaper for attaching, to a wall surface, the bracket and the auxiliary bracket both included in the attachment system according to claim 8, the wallpaper showing an attachment area for the bracket and an attachment area for the auxiliary bracket, the attachment area for the bracket being equal in size to the bracket, the attachment area for the auxiliary bracket being equal in size to the auxiliary bracket.

The wallpaper shows the respective attachment areas for the bracket and the auxiliary bracket, the respective attachment areas being equal in size to the bracket and the auxiliary bracket. This arrangement facilitates attachment of the bracket and the auxiliary bracket to a wall surface.

A display device of the present invention is a display device including: a frame section surrounding a display section; and at least one antenna for a wireless telecommunication, the at least one antenna including an antenna element provided so as to jut out from an outer edge of the frame section.

If the antenna were disposed in its entirety at such a position on the display section side of the display device as to coincide with the frame section, the antenna would have, for signal transmission, a beam direction having a range influenced by the display section and the frame section to cover a space located in a forward direction of the display device with the antenna as the center (that is, a space corresponding to about half of all directions). If the antenna were disposed at such a position on the back surface side of the display section as to coincide with the frame section, the antenna would have, for signal transmission, a beam direction having a range influenced by the display section and the frame section to cover a space located in a backward direction of the display device with the antenna as the center (that is, a space corresponding to about half of all directions).

Disposing the antenna as in the above arrangement, that is, so that the antenna element juts out from the outer edge of the frame section, in contrast, allows the beam direction of the antenna to have a range corresponding to a space from the forward direction of the display device to the backward direction of the display device. Disposing the antenna as above thus increases the open space for the antennas and further reduces the limit on the beam direction of the antennas. Consequently, the above arrangement can, without increasing the thickness of the display device and while keeping its picture frame narrow and the thickness small, suitably prevent the transmission capability from decreasing depending on the incoming direction of radio waves.

The present invention includes in its scope a television receiver including the display device.

### Advantageous Effects of Invention

The present invention is a bracket for hanging a target object on a wall surface for attachment of the target object to the wall surface, the target object being provided with a pin attached to the target object, the bracket including: a back board section to be attached to the wall surface; and a front board section facing the back board section, the front board section having at least one guide slot extending from an upper end of the front board section in a downward direction, the back board section and the front board section being separated from each other by a clearance that is large at an upper portion and small at a lower portion so that a head section of the pin of which a neck section is fitted in the guide slot is sandwiched between the back board section and the front board section.

With this arrangement, attaching a target object to a wall surface merely requires moving the pin, attached to the target object, downward along the guide slot. The above arrangement thus facilitates the attachment of a target object to a wall surface. Further, detaching a target object from a wall surface merely requires moving the target object upward along the guide slot. The above arrangement thus facilitates the detachment of a target object from a wall surface. After the attachment, the pin being sandwiched in the guide slot can prevent the target object and the wall surface from being possibly shaken relative to each other when, for instance, an earthquake occurs, thereby preventing the target object from being detached unexpectedly from the wall surface.

### BRIEF DESCRIPTION OF DRAWINGS

(a) of FIG. 1 is an enlarged perspective view of a bracket. (b) of FIG. 1 is a cross-sectional view of the bracket as taken along line Z-Z′ in (a) of FIG. 1.

(a) of FIG. 2 is a perspective view of a television and an attachment system as taken in a direction toward the frontal surface of the television. (b) of FIG. 2 is a perspective view of the television and the attachment system as taken in a direction toward a back surface of the television. The symbol “AQUAS” shown in FIG. 2 is a registered trademark.

(a) of FIG. 3 is a perspective view of a television as it is attached to a bracket and an auxiliary bracket, the view being taken in a direction toward the frontal surface of the television. (b) of FIG. 3 is a perspective view of the television in the state illustrated in (a) of FIG. 3, the view being taken in a direction toward the back surface of the television.

(a) of FIG. 4 is an elevational view of a bracket. (b) of FIG. 4 is a side view of the bracket. (c) of FIG. 4 is a top view of the bracket. (d) of FIG. 4 is a cross-sectional view of the bracket as taken along line A-A in (a) of FIG. 4. (e) of FIG. 4 is a rear view of the bracket.

(a) of FIG. 5 is an elevational view of an auxiliary bracket. (b) of FIG. 5 is a side view of the auxiliary bracket. (c) of FIG. 5 is a top view of the auxiliary bracket. (d) of FIG. 5 shows cross-sectional views of the auxiliary bracket as taken along line X′-X′, line X-X, and line X″-X″ in (a) of FIG. 5. (e) of FIG. 5 is a cross-sectional view of the auxiliary bracket as taken along line Y-Y in (a) of FIG. 5. (f) of FIG. 5 is a rear view of the auxiliary bracket.

FIG. 6 is a perspective view of a locking pin as taken from a head section side.

(a) of FIG. 7 is a front view (elevational view) of a locking pin, the view being taken from a head section side. (b) of FIG. 7 is a side view of the locking pin.

(a) of FIG. 8 is a perspective view of a locking pin, the view being taken from a shaft section side. (b) of FIG. 8 is a cross-sectional view of the locking pin.

FIG. 9 is a perspective view of a locking pin as taken from a head section side.

(a) of FIG. 10 is a front view (elevational view) of a locking pin, the view being taken from a head section side. (b) of FIG. 10 is a side view of the locking pin.

(a) of FIG. 11 is an elevational view illustrating how each locking pin is moved with respect to the attachment system. (b) of FIG. 11 is a perspective view illustrating the same.

FIG. 12 is a side view of a television as it is attached to an attachment system.

FIG. 13 is a diagram illustrating an example paper pattern for use in attaching an attachment system to a wall surface.

FIG. 14 is a perspective view of a television as taken in a direction toward the back surface thereof. The symbol “AQUOS” shown in FIG. 14 is a registered trademark.

(a) of FIG. 15 is a perspective view of a television as taken in a direction toward the frontal surface thereof. (b) of FIG. 15 is a perspective view of the television as taken in a direction toward the back surface thereof. The symbol “AQUOS” shown in FIG. 15 is a registered trademark.

(a) of FIG. 16 is an enlarged view of a portion encircled by a dotted line in (a) of FIG. 15. (b) of FIG. 16 is an enlarged view of a portion encircled by a dotted line in (b) of FIG. 15.

(a) of FIG. 17 is a view corresponding to (a) of FIG. 16 with a cover detached. (b) of FIG. 17 is a view corresponding to (b) of FIG. 16 with a cover detached.

FIG. 18 is a side view of a television, the view illustrating a general direction (beam direction) in which an antenna emits a beam.

(a) of FIG. 19 is a perspective view of a television provided a stationary placement stand, the view being taken from above in a direction toward the frontal surface of the television. (b) of FIG. 19 is a perspective view of the television provided with a stationary placement stand, the view being taken in a direction toward the back surface of the television. (c) of FIG. 19 is a perspective view of the television provided with a stationary placement stand, view being taken from below in a direction toward the frontal surface of the television. The symbol “AQUOS” shown in FIG. 19 is a registered trademark.

FIG. 20 is an enlarged view of a portion enclosed by a solid line in (c) of FIG. 19 with a cover detached.

FIG. 21 is a view of an example of a wall-mounting metal fitting.

FIG. 22 shows exploded perspective views each schematically illustrating a configuration of a television of one embodiment of the present invention. (a) of FIG. 22 is a perspective view of the television as taken in a direction toward the back surface thereof. (b) of FIG. 22 is an enlarged view corresponding to part of (a) of FIG. 22.

FIG. 23 shows exploded perspective views each schematically illustrating a configuration of a television of one embodiment of the present invention. (a) of FIG. 23 is a perspective view of the television as taken in a direction toward the frontal surface of the television. (b) of FIG. 23 is an enlarged view corresponding to a portion enclosed by a line in (a) of FIG. 23.

FIG. 24 is a cross-sectional view of a portion of a television of one embodiment of the present invention to which portion a frame is fixed.

FIG. 25 is a cross-sectional view of a portion of a television of one embodiment of the present invention to which portion a back surface cover is fixed.

FIG. 26 is a view of an antenna disposed in a television of one embodiment of the present invention, the view being taken in a direction toward a display section of the television.

FIG. 27 is a rear view of the antenna in FIG. 26.

### DESCRIPTION OF EMBODIMENTS

An embodiment of the present invention is described below with reference to the drawings. The present invention is, however, not limited to this embodiment. The description below mentions dimensions, shapes and the like for this embodiment, which are not intended to limit the scope of the present invention to such dimensions, shapes and the like and which are mere illustrative examples unless otherwise particularly limited.

With reference to FIGS. 2 and 3, the description below deals first with a preferable embodiment of a system of the present invention for attaching a target object.

(a) of FIG. 2 is a perspective view of (i) a television (television receiver) 100 as a target object and (ii) an attachment system for attaching the television 100 to a wall surface, the view being taken in a direction toward the front surface of the television 100 (that is, from its display section side; from the forward direction side along the Z axis). (b) of FIG. 2 is a perspective view of the television 100 and the attachment system, the view being taken in a direction toward the back surface of the television 100 (that is, from the backward direction side along the Z axis).

The television 100 is a wall-mountable flat-screen display device. The television 100 weighs, for example, approximately 5.2 kilograms for a 32-inch size or approximately 8.5 kilograms for a 40-inch size. The television 100 will be described in detail later.

The attachment system of the present embodiment includes (i) a bracket 10, (ii) an auxiliary bracket 20, (iii) locking pins (pin) 30 to be fitted into the bracket 10, and (iv) a locking pin 40 to be fitted into the auxiliary bracket 20. The bracket 10 and the auxiliary bracket 20 are attached to a wall surface at such respective positions as to be separated from each other by a predetermined distance. The television 100 is attached to a wall surface by (i) fitting the locking pins 30, which are threadedly engaged with an upper portion of the back surface of the television 100, into the bracket 10 and further (ii) fitting the locking pin 40, which is threadedly engaged with a lower portion of the back surface of the television 100, into the auxiliary bracket 20.

(a) of FIG. 3 is a perspective view of the television 100, the view being taken in a direction toward the front surface thereof as it is attached to the bracket 10 and the auxiliary bracket 20. (b) of FIG. 3 is a perspective view of the television 100, the view being taken in a direction toward the back surface thereof as it is in the state illustrated in (a) of FIG. 3. (b) of FIG. 3 omits illustration of a wall surface 50 for convenience of explanation.

The television 100 is, as illustrated in (a) and (b) of FIG. 3, hung on the bracket 10 and the auxiliary bracket 20 to be attached to the wall surface 50.

(Bracket 10)

The description below deals with the bracket 10 with reference to FIGS. 1 and 4. (a) of FIG. 1 is an enlarged perspective view of the bracket 10. (b) of FIG. 1 is a cross-sectional view of the bracket 10 as taken along line Z-Z′ in (a) of FIG. 1. (a) of FIG. 4 is an elevational view of the bracket 10. (b) of FIG. 4 is a side view of the bracket 10. (c) of FIG. 4 is a top view of the bracket 10. (d) of FIG. 4 is a cross-sectional view of the bracket 10 as taken along line A-A in (a) of FIG. 4. (e) of FIG. 4 is a rear view of the bracket 10.

The bracket 10 is, as illustrated in FIGS. 1 and 4, a structure including (i) a back board section 11, (ii) an upper board section 13, (iii) a front board section 14, and (iv) a lower board section 15, the structure having a void inside. The bracket 10 is open on both sides with a void 19 formed inside and extending from one side to the other. The bracket 10 can be made of a metal, more specifically, aluminum. The present embodiment is, however, not limited to such an arrangement.

The back board section 11 is, as illustrated in (b) of FIG. 1 and (a) of FIG. 4, a rectangular board-shaped member, and includes (i) an upper fringe 11a extending upward from a joint at which the back board section 11 is joined with the upper board section 13 and (ii) a lower fringe 11b extending downward from a joint at which the back board section 11 is joined with the lower board section 15. The upper fringe 11a and the lower fringe 11b, as illustrated in (a) and (e) of FIG. 4, each have a plurality of through holes 18. The back board section 11 is attached to the wall surface 50 by means of screws or nails through the through holes 18. The back board section 11 is attached to the wall surface 50 in such an orientation that the long sides of the back board section 11 are horizontal.

In the case where the wall surface 50 to which the television 100 is attached is made of wood, the back board section 11 is attached to the wall surface 50 with use of, among the plurality of through holes 18 illustrated in (a) of FIG. 4, (i) two through holes 18 located next to each other vertically on the central axis of the back board section 11 (that is, the through holes 18 located on the dotted-and-dashed line A-A) and (ii) through holes 18 located at the four corners of the back board section 11. In the case where the wall surface 50 is a plaster board, the back board section 11 is attached to the wall surface 50 with use of all the through holes 18 illustrated in (a) of FIG. 4. As described above, the material of a wall surface to which the back board section 11 is attached determines which through holes 18 to use. With this arrangement, the television 100 can be attached to a wall surface 50 made of any of various materials as long as it is a material that allows the television 100 to be attached with use of screws or nails.

The front board section 14 is a rectangular board-shaped member. The front board section 14 is fixed to the back board section 11 via the upper board section 13 and the lower board section 15 in such an orientation as to have (i) a board surface parallel to the board surface of the back board section 11 and as to have (ii) long sides parallel to the long sides of the back board section 11.

The front board section 14, as illustrated in (a) of FIG. 4, has two guide slots 17. The guide slots 17 each have a width that is (i) larger than the diameter of a cylindrical section 32 of a locking pin 30 illustrated in (b) of FIG. 7 and that is (ii) smaller than the diameter of a head section 31 of that locking pin 30. The guide slots 17 each serve to lock a locking pin 30, fixed to the back surface of the television 100, at a lower portion of the guide slot 17. The guide slots 17 are each bent. Specifically, the guide slots 17 are each in the shape of the character “<” as illustrated in (a) of FIG. 4. More specifically, as illustrated in (a) of FIG. 4, each guide slot upper portion 17a extends from the upper edge of the front board section 14 in a lower-right direction, whereas each guide slot lower portion 17b extends from the lower end of the guide slot upper portion 17a in a lower-left direction. The guide slots 17 may, needless to say, be shaped such that each guide slot upper portion 17a extends from the upper edge of the front board section 14 in a lower-left direction and that each guide slot lower portion 17b extends from the lower end of the guide slot upper portion 17a in a lower-right direction.

The bracket 10 has a down taper structure in which the front board section 14 and the back board section 11 are separated from each other by a clearance that is large at an upper portion and small at a lower portion. This structure intends to sandwich the head section 31 of each locking pin 30 between the front board section 14 and the back board section 11 in order to prevent the television 100 from being possibly shaken in a front-back direction when, for instance, an earthquake occurs. The present embodiment is, in particular, arranged to achieve the down taper structure with use of a front board section 14 having a thicker lower portion that juts out toward the back board section 11. This arrangement allows the television 100 to be fixed closely to the wall surface 50, thus more reliably preventing the television 100 from being possibly shaken in a front-back direction when, for instance, an earthquake occurs.

The upper board section 13 has opening sections 16 that are each continuous with a guide slot 17 in the front board section 14. The opening sections 16 are each in a rectangular shape as viewed in the direction normal to the upper board section 13. The opening sections 16 are designed to be larger in size than the head section 31 of each locking pin 30 so that the respective head sections 31 of the locking pins 30 can be inserted into the bracket 10 via the opening sections 16. The upper board section 13 is, when the back board section 11 is attached to the wall surface 50, inclined downward with respect to a forward direction (that is, with respect to a direction from the back board section 11 side to the front board section 14 side).

If the bracket 10 were arranged such that a worker could place the television 100 on the bracket 10, the worker might, after placing the television 100 on the bracket 10, suspend their attachment work with the television 100 left on the bracket 10. In such a case, a shake would cause the television 100 to drop from the bracket 10. The upper board section 13 is, however, inclined with respect to the forward direction. This arrangement makes it impossible to place the television 100 stably on the bracket 10, and thus prevents the television 100 from being placed unstably on the bracket 10.

(Auxiliary Bracket 20)

The description below deals with the auxiliary bracket 20 with reference to FIG. 5. (a) of FIG. 5 is an elevational view of the auxiliary bracket 20. (b) of FIG. 5 is a side view of the auxiliary bracket 20. (c) of FIG. 5 is a top view of the auxiliary bracket 20. (d) of FIG. 5 shows cross-sectional views of the auxiliary bracket 20 as taken along line X′-X′, line X-X, and line X″-X″ in (a) of FIG. 5. (e) of FIG. 5 is a cross-sectional view of the auxiliary bracket 20 as taken along line Y-Y in (a) of FIG. 5. (f) of FIG. 5 is a rear view of the auxiliary bracket 20.

The auxiliary bracket 20 includes a back board section 21, which has a rail groove 22. The auxiliary bracket 20 is made of a metal, more specifically aluminum. The present embodiment is, however, not limited to such an arrangement.

The back board section 21 is a square board-shaped member. The back board section 21 has a plurality of through holes 28. The back board section 21 is attached to the wall surface 50 by means of screws or nails through the through holes 28. The back board section 21 is attached to the wall surface 50 in such an orientation as to have a horizontal upper side. The back board section 21 is attached to the wall surface 50 as separated from the bracket 10 by a predetermined distance.

In the case where the wall surface 50 to which the television 100 is attached is made of wood, the back board section 21 is attached to the wall surface 50 with use of, among the plurality of through holes 28 illustrated in (a) of FIG. 5, through holes 28 located at the four corners of the back board section 21. In the case where the wall surface 50 is a plaster board, the back board section 21 is similarly attached to the wall surface 50 with use of through holes 28 located at the four corners of the back board section 21. With this arrangement, the auxiliary bracket 20 can be attached to a wall surface 50 made of any of various materials as long as it is a material that allows the auxiliary bracket 20 to be attached with use of screws or nails.

The rail groove 22 causes the locking pin 40, fixed to the back surface of the television 100, to be engaged inside the rail groove 22. The rail groove 22 is so formed in the back board section 21 as to be parallel to each guide slot lower portion 17b of the bracket 10. In the case where, for instance, each guide slot lower portion 17b of the bracket 10 extends from the lower end of a guide slot upper portion 17a in a lower-left direction as illustrated in FIG. 4, the rail groove 22 is so formed as to extend from an upper left portion of the back board section 21 in a lower-right direction as illustrated in (a) of FIG. 5.

The rail groove 22 has an opening section 23 that is open toward a direction perpendicular to the board surface of the back board section 21. The rail groove 22 has an inside width that is designed to be larger in size than the head section 41 of the locking pin 40 so that the head section 41 of the locking pin 40 (see FIG. 10) can be inserted into the rail groove 22 through an entry section 24 located at an upper left portion of the back board section 21. The opening section 23 of the rail groove 22 is so formed as to have a width that is (i) larger than the diameter of a cylindrical section 42 of the locking pin 40 and that is (ii) smaller than the diameter of the head section 41.

The above structure allows the head section 41 of the locking pin 40 to be easily fitted into the rail groove 22. In the case where the head section 31 of each locking pin 30 has been fitted into a guide slot 17, but the head section 41 of the locking pin 40 has failed to be fitted into the rail groove 22, another attempt to fit the head section 41 of the locking pin 40 into the rail groove 22 can be made by, instead of detaching the respective head sections 31 of the locking pins 30 from the guide slots 17, merely moving the respective head sections 31 of the locking pins 30 to the respective lower ends of the guide slot upper portions 17a.

(Locking Pins 30)

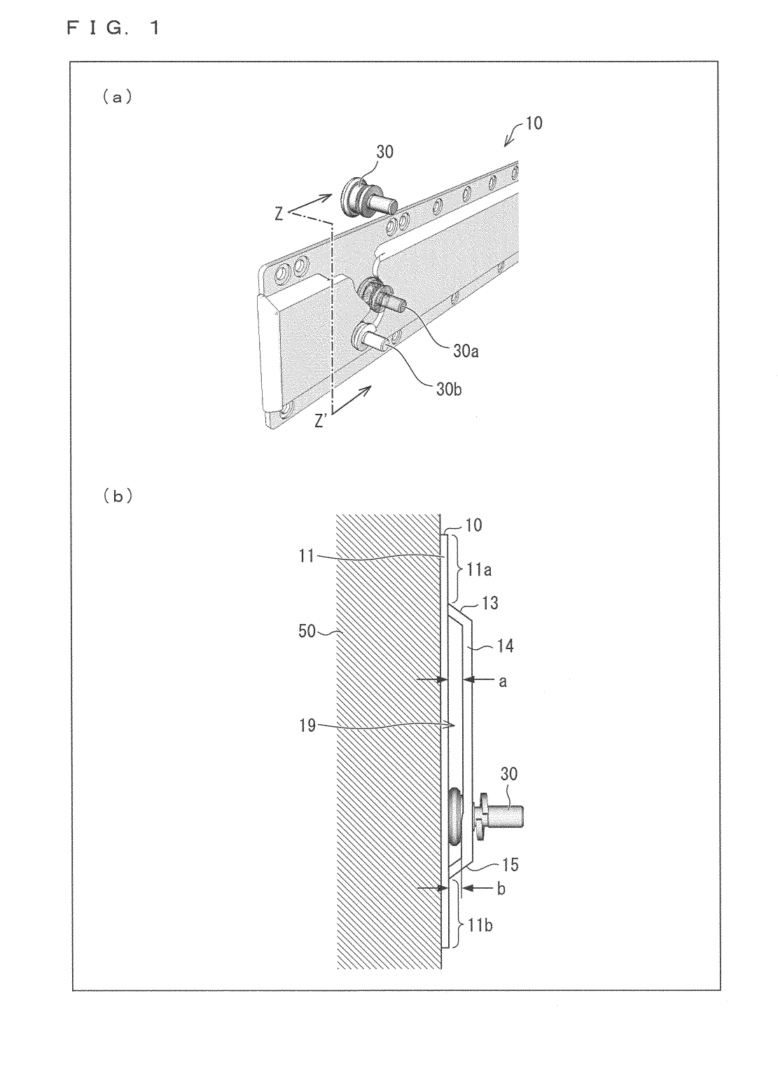

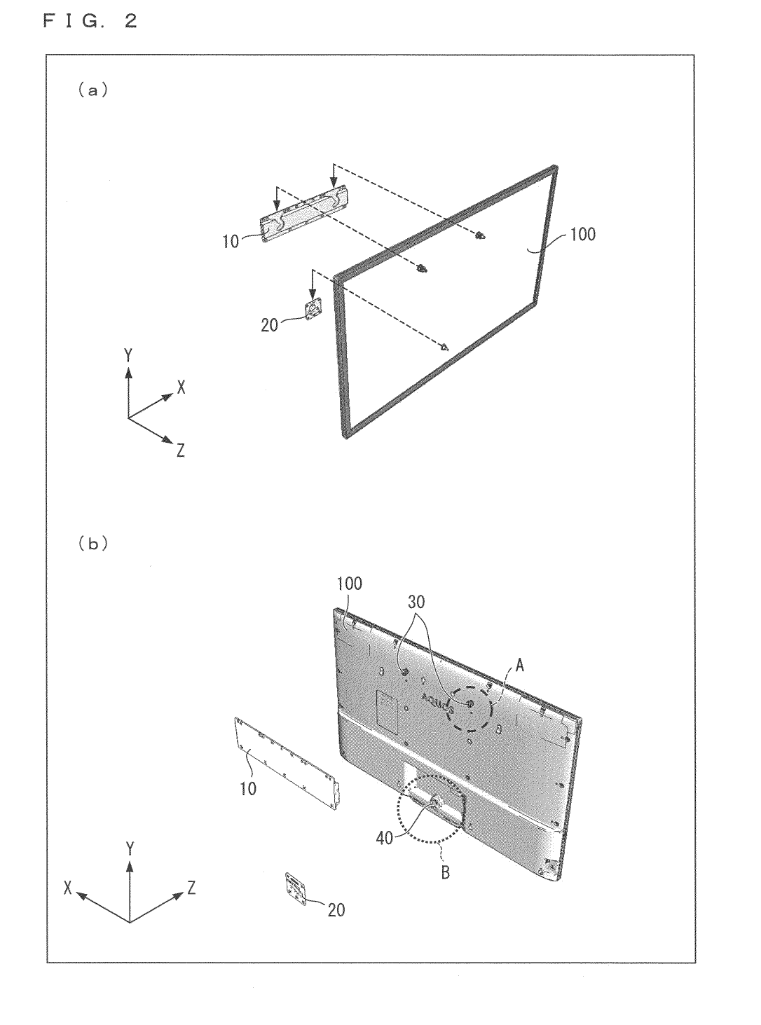

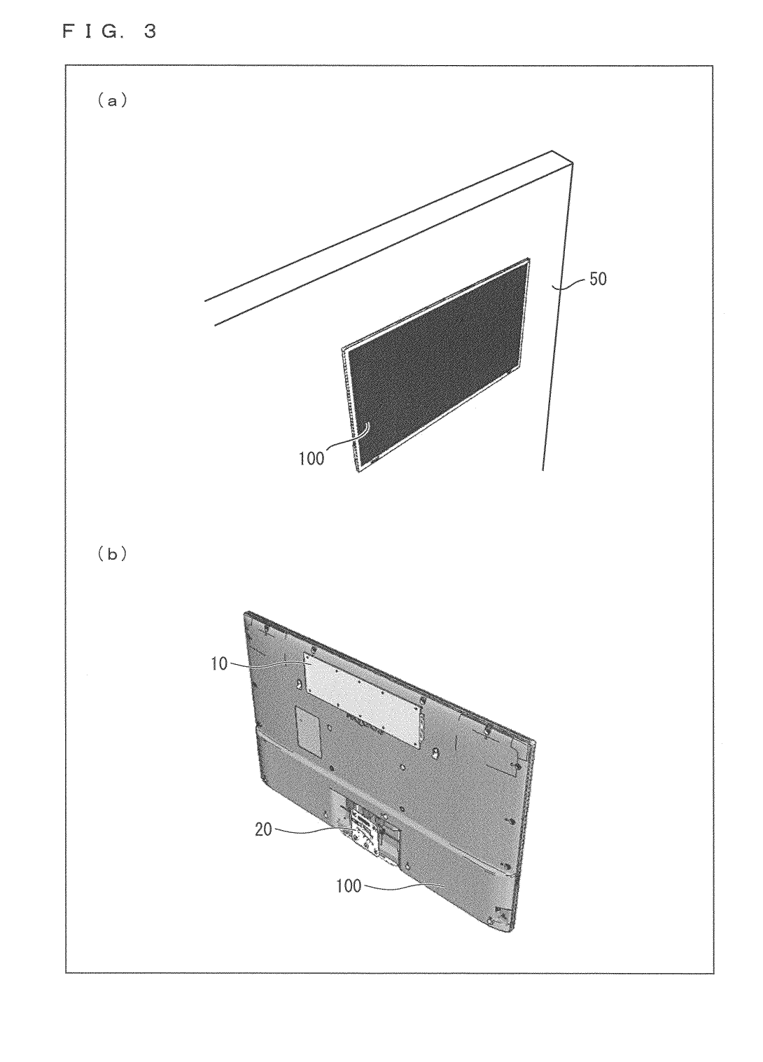

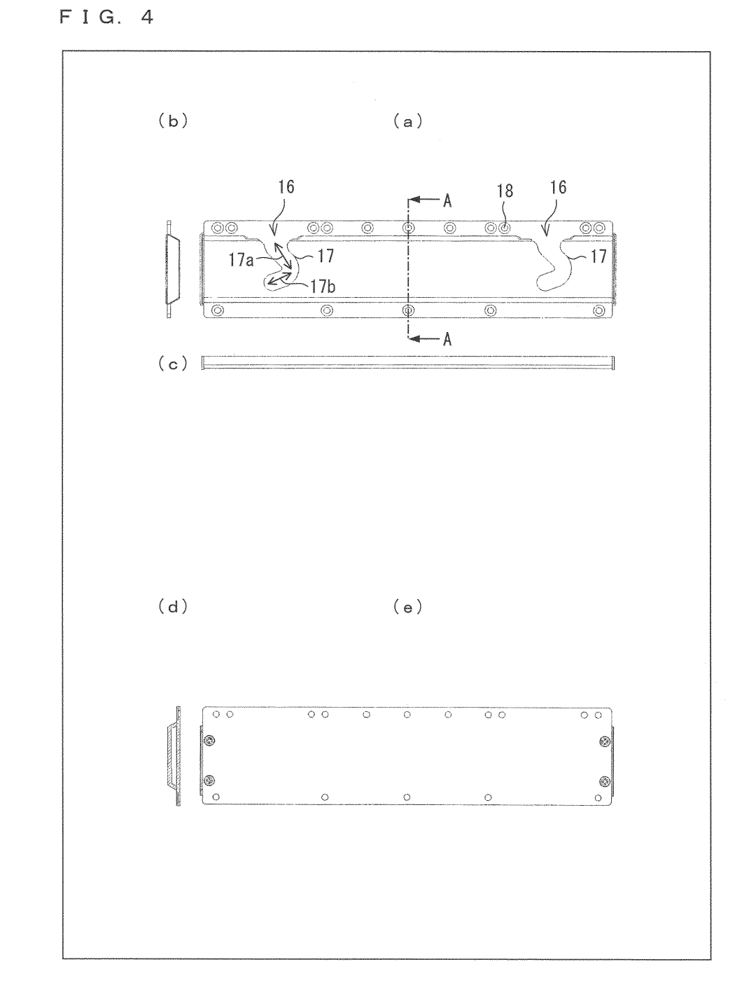

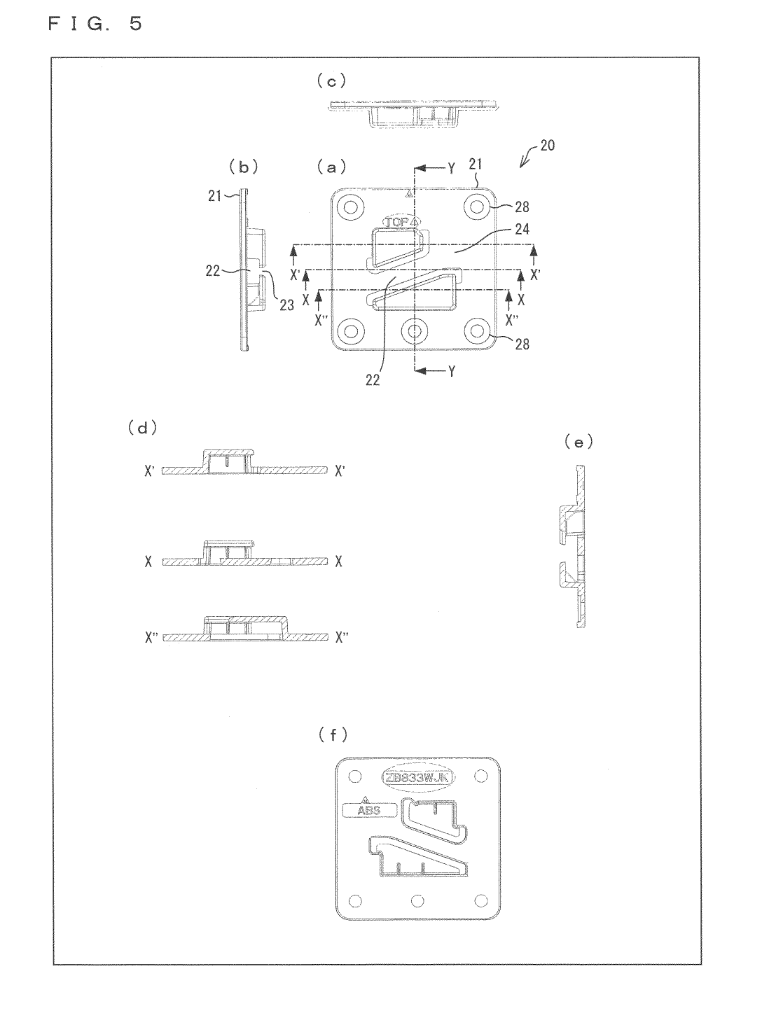

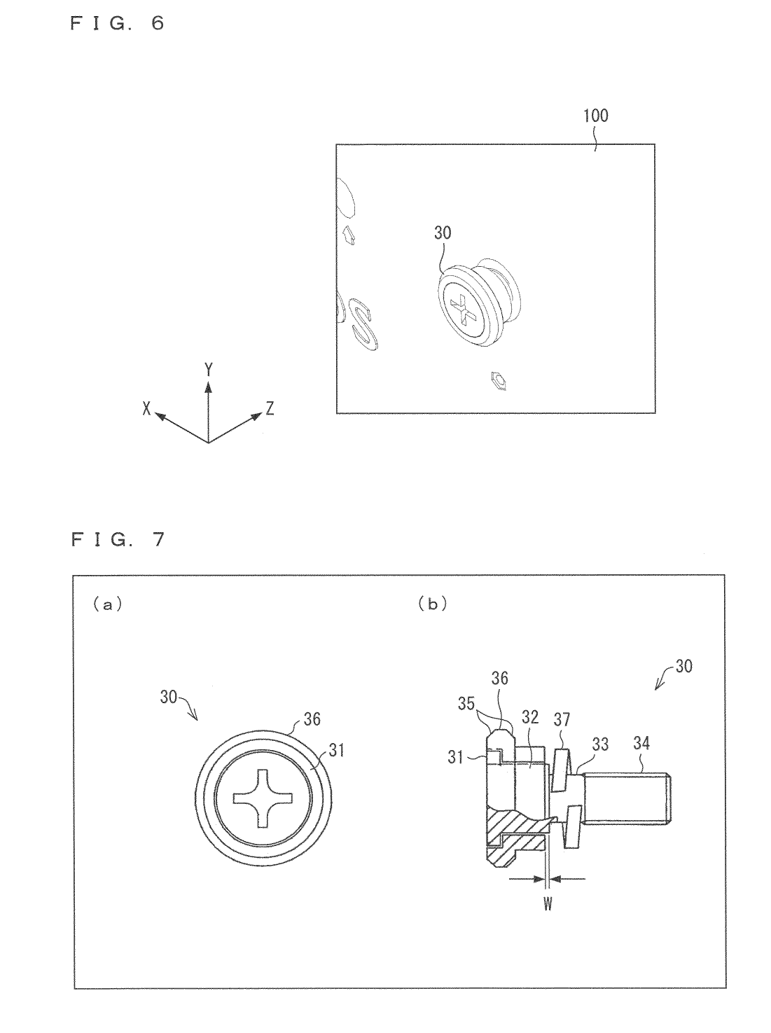

The description below deals with the locking pins 30 with reference to FIGS. 6 through 8. FIG. 6 is a perspective view of a locking pin 30, the view being taken from the head section 31 side. FIG. 6 is an enlarged view of a portion A encircled by a dotted line in (b) of FIG. 2. (a) of FIG. 7 is a front view (elevational view) of a locking pin 30, the view being taken from the head section 31 side. (b) of FIG. 7 is a side view of a locking pin 30. (a) of FIG. 8 is a perspective view of a locking pin 30, the view being taken from the shaft section 34 side. (b) of FIG. 8 is a cross-sectional view of a locking pin 30.

The locking pins 30, as illustrated in FIGS. 6 through 8, each include (i) a head section 31, (ii) a cylindrical section 32, (iii) a neck section 33, (iv) a shaft section 34, and (v) a rotary section (rotary slider) 36. The neck section 33 is provided with a spring washer 37 fitted thereon. The locking pins 30 are made of a metal, more specifically aluminum. The present embodiment is, however, not limited to such an arrangement.

The head section 31 is a disk-shaped member with a predetermined thickness. The head section 31 has chamfer sections 35 formed by obliquely chamfering the head section 31. This structure allows the locking pins 30 to be fitted into the bracket 10 easily. The locking pins 30 are each threadedly engaged with an upper portion of the back surface of the television 100 at the shaft section 34 as illustrated in FIG. 6.

The rotary section 36 is a rotary slider that is slid along a guide slot 17. The rotary section 36 is fitted with the head section 31 and cylindrical section 32 inserted therein. Stated differently, the rotary section 36 is so formed as to cover the head section 31 and the cylindrical section 32. The cylindrical section 32 has a portion that is not covered by the rotary section 36, the portion extending from the end adjacent to the neck section 33 over a distance W to form a gap. This gap allows, when a locking pin 30 is fitted in a guide slot 17, the rotary section 36 alone to rotate.

Note that the individual parts of a locking pin 30 are named as above merely for convenience. Thus, the description herein may, for example, alternatively use the term “neck section” to refer to the combination of (i) the above-described cylindrical section 32 of a locking pin 30 and (ii) a portion of the rotary section 36 which portion covers the cylindrical section 32, or alternatively use the term “head section” to refer to the combination of (i) the head section 31 and (ii) a portion of the rotary section 36 which portion covers the head section 31.

(Locking Pin 40)

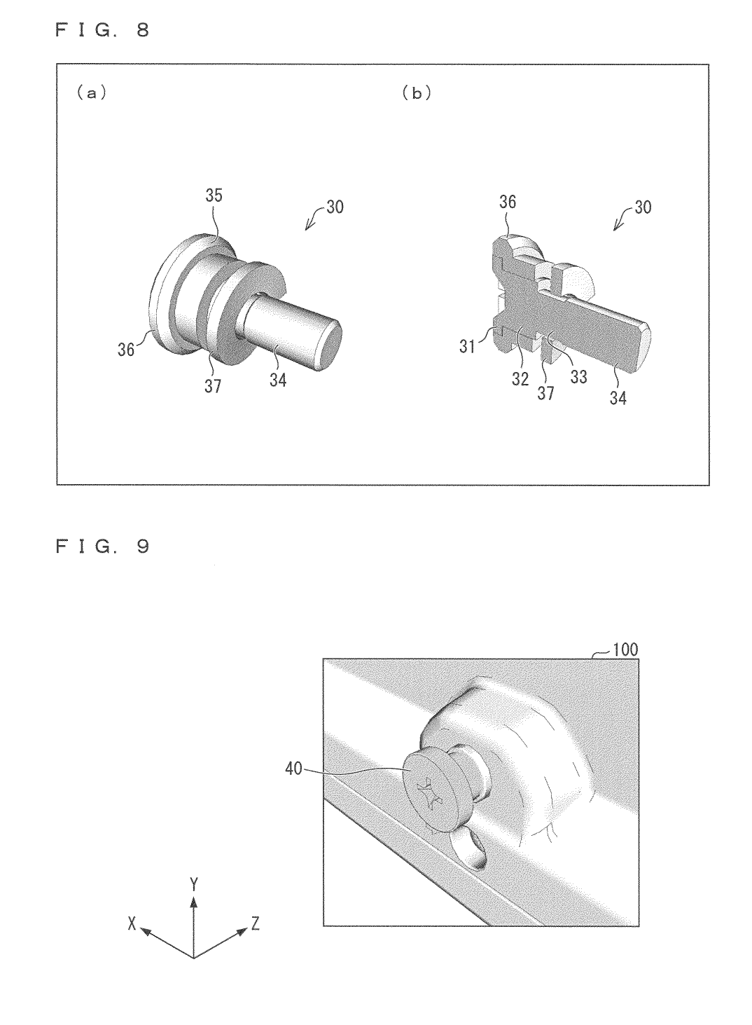

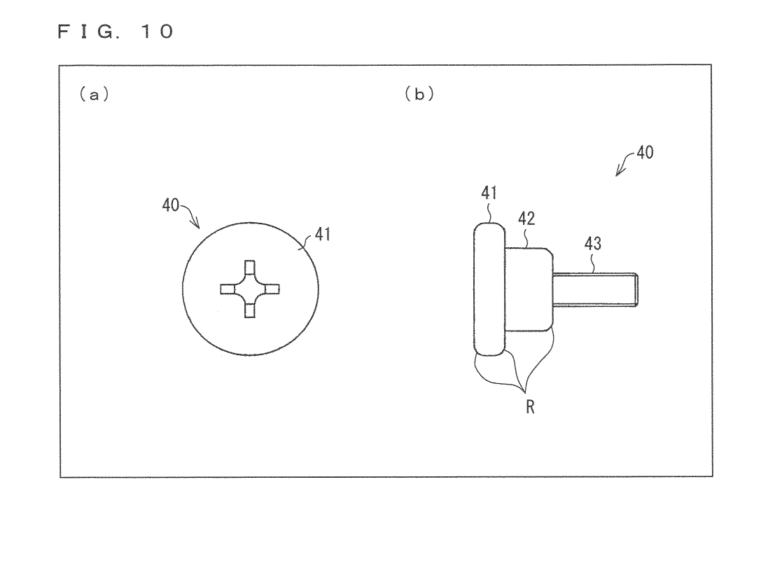

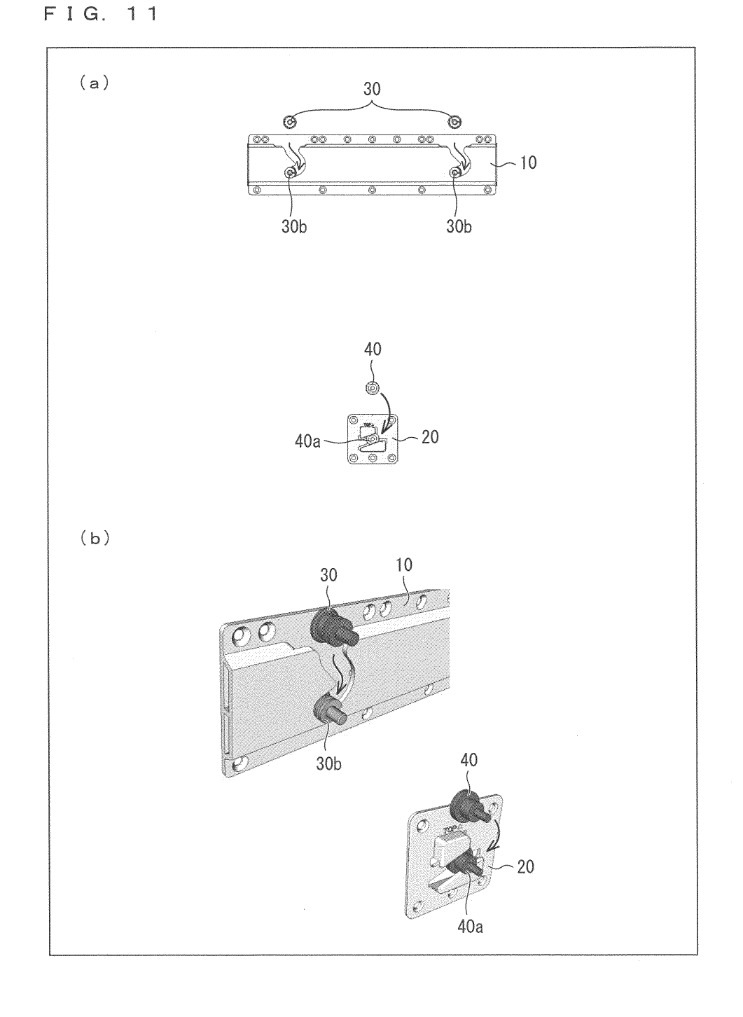

The description below deals with the locking pin 40 with reference to FIGS. 9 and 10. FIG. 9 is a perspective view of the locking pin 40, the view being taken from the head section 41 side. FIG. 9 is an enlarged view of a portion A encircled by a dotted line in (b) of FIG. 2. (a) of FIG. 10 is a front view (elevational view) of the locking pin 40, the view being taken from the head section 41 side. (b) of FIG. 10 is a side view of the locking pin 40.

The locking pin 40, as illustrated in FIGS. 9 and 10, includes (i) a head section 41, (ii) a cylindrical section 42, and (iii) a shaft section 43. The head section 41 and the cylindrical section 42 have each been subjected to round chamfering R. This structure allows the locking pin 40 to be fitted into the auxiliary bracket 20 easily. The locking pin 40 is threadedly engaged with a lower portion of the back surface of the television 100 at the shaft section 43 as illustrated in FIG. 9.

The head section 41 of the locking pin 40 is a disk-shaped member with a predetermined thickness. The locking pin 40 is made of a metal, more specifically aluminum. The present embodiment is, however, not limited to such an arrangement.

(How Locking Pins 30 and Locking Pin 40 are Moved with Respect to Bracket 10 and Auxiliary Bracket 20)

With reference to FIGS. 1 and 11, the description below deals with how the locking pins 30 and the locking pin 40 are moved with respect to the bracket 10 and the auxiliary bracket 20. (a) of FIG. 11 is an elevational view illustrating how the locking pins 30 and the locking pin 40 are moved with respect to the bracket 10 and the auxiliary bracket 20. (b) of FIG. 11 is a perspective view illustrating the same. FIGS. 1 and 11 assume that the locking pins 30 and the locking pin 40 are threadedly engaged with the television 100.

The description below assumes that a user is holding the television 100 in such an orientation that the television 100 is parallel to the long sides of the bracket 10 and that the user will fit the respective head sections 31 of the locking pins 30, which are threadedly engaged with the television 100, into the bracket 10 from above the bracket 10. In this state, the locking pins 30 are located above the bracket 10 as illustrated in FIGS. 1 and 11. The locking pin 40 is similarly located above the auxiliary bracket 20.

When the user fits the respective head sections 31 of the locking pins 30 into the bracket 10 from above, the locking pins 30 enter the guide slots 17 of the bracket 10 smoothly as the respective rotary sections 36 rotate. This results in each locking pin 30 (i) moving to the position indicated by a locking pin 30a in (a) of FIG. 1 and then (ii) being locked at the position indicated by a locking pin 30b. In this state, the locking pins 30 are sandwiched between the front board section 14 and the back board section 11 as illustrated in (b) of FIG. 1. The locking pins 30 are firmly fixed in the bracket 10 as a result.

The user fits the respective head sections 31 of the locking pins 30 into the bracket 10 as illustrated in FIG. 11 in such an orientation that the television 100 is parallel to the long sides of the bracket 10. The two locking pins 30 are accordingly moved identically to the respective positions indicated by the locking pins 30b. The locking pin 40 is moved in synchronization with the movement of the locking pins 30 to the respective positions indicated by the locking pins 30b. The locking pin 40 is moved to the position of a locking pin 40a in the rail groove 22 of the auxiliary bracket 20 illustrated in (b) of FIG. 11 to be engaged with the rail groove 22.

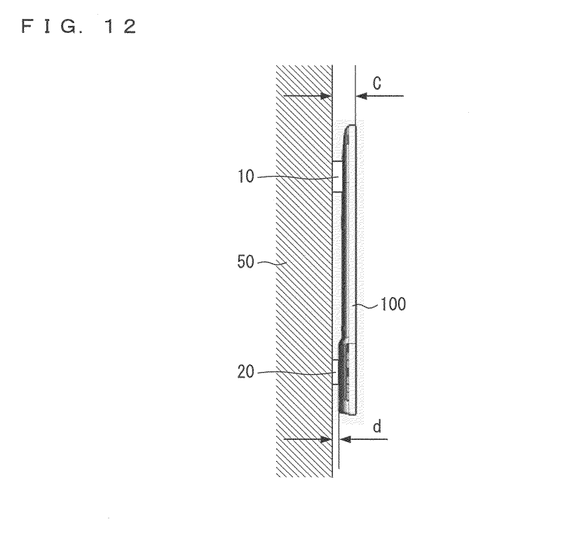

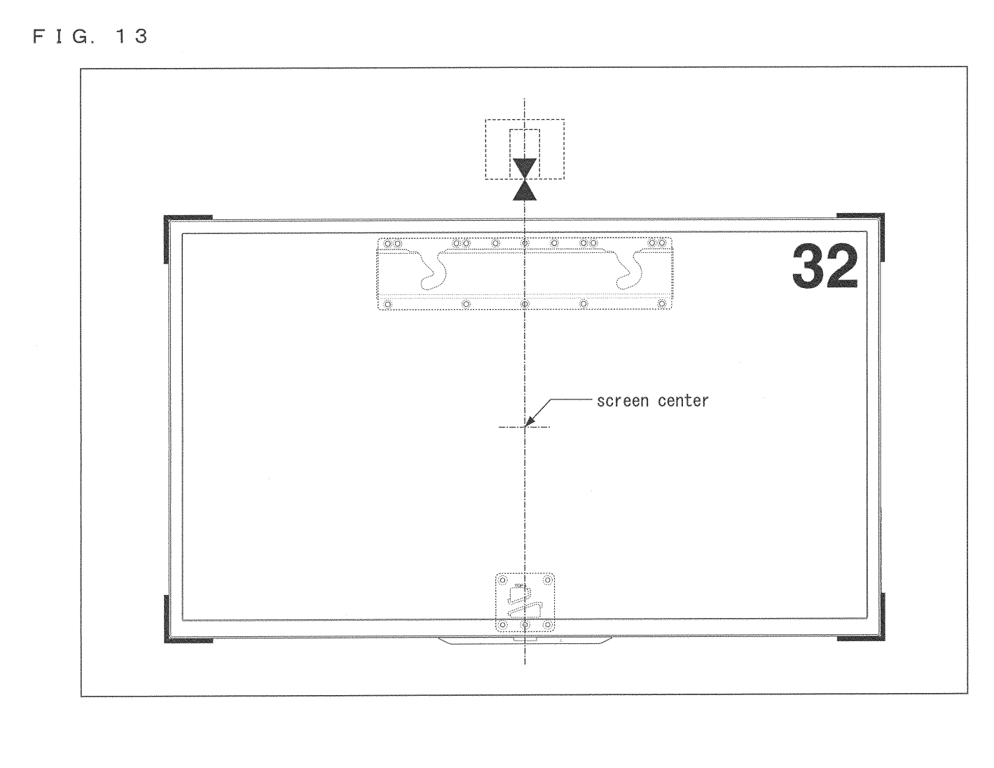

FIG. 12 is a side view of the television 100 as it is attached to the attachment system. The television 100 is, as illustrated in FIG. 12, attached to the attachment system at three points by means of the two locking pins 30 and the locking pin 40. The television 100 in this state is separated from the wall surface 50 by only a width d that is equal to the thickness of the attachment system, for example, 9 mm. This means that in the case where the television 100 has a thickness of, for example, 29 mm, the frontal surface of the television 100 is separated from the wall surface 50 by a distance c of 38 mm.

As described above, attaching the two locking pins 30 and the locking pin 40 to the attachment system allows the television 100 to be attached to the wall surface 50 easily.

The attachment system of the present embodiment, as described above, includes a bracket 10 for attaching, to a wall surface 50, a television 100 provided with locking pins 30 that are fixed thereto to attach the television 100 to the wall surface 50. The bracket 10 includes (1) a back board section 11 to be attached to the wall surface in such an orientation as to have horizontal long sides, (2) an upper board section 13 and a lower board section 15 both joined with the back board section 11, and (3) a front board section fixed to the back board section 11 via the upper board section 13 and the lower board section 15 in such an orientation as to have a board surface parallel to the board surface of the back board section 11 and as to have long sides parallel to the long sides of the back board section 11. The front board section 14 has guide slots 17. The upper board section 13 has opening sections 16 that are each continuous with a guide slot 17. The bracket 10 has a down taper structure in which the front board section 14 and the back board section 11 are separated from each other by a clearance that is large at an upper portion and small at a lower portion.

The bracket 10 of the present embodiment may also be described as being a bracket for hanging a television 100 on a wall surface for attachment of the television 100 to the wall surface, the television 100 being a target object provided with locking pins 30 attached thereto, the bracket including: a back board section 11 to be attached to the wall surface; and a front board section 14 facing the back board section 11, the front board section 14 having guide slots 17 extending from an upper end of the front board section 14 in a downward direction, the back board section 11 and the front board section 14 being separated from each other by a clearance that is large at an upper portion and small at a lower portion so that the head section of each locking pin 30 of which the neck section is fitted in a guide slot is sandwiched between the back board section 11 and the front board section 14.

With the above structure, the head section 31 of each locking pin 30 inserted in a guide slot 17 through an opening section 16 is sandwiched between the front board section 14 and the back board section 11. The head section 31 of each locking pin 30 is, as the locking pin 30 is moved to the guide slot lower portion 17b along the guide slot 17, sandwiched further between the front board section 14 and the back board section 11 to be fixed. With this arrangement, attaching a television 100 to a wall surface 50 merely requires moving the locking pins 30, attached to the television 100, downward along the guide slots 17. The above arrangement thus facilitates the attachment of a television 100 to a wall surface 50. Further, detaching a television 100 from a wall surface 50 requires moving the television 100 upward along the guide slots 17. The above arrangement thus facilitates the detachment of a television 100 from a wall surface 50. After the attachment, the locking pins 30 being locked in the guide slots 17 can prevent the television 100 from being possibly shaken in a front-back direction when, for instance, an earthquake occurs. This arrangement prevents the television 100 from being detached unexpectedly from the wall surface.

The down taper structure of the present embodiment is a structure in which the front board section 14 juts out at a lower portion toward the back board section 11.

The above structure may be described as being a structure in which the front board section 11 has a surface facing the back board section 14 which surface juts out at a lower portion toward the back board section so that the clearance between the back board section 11 and the front board section 14 is large at the upper portion and small at the lower portion.

In the case where the bracket 10 is structured such that the back board section 11 juts out toward the front board section 14, the television 100 is separated from the wall surface 50 by a gap when the television 100 is attached to the wall surface 50. The above structure, however, allows the television 100 to be fixed closely to the wall surface 50, thus more reliably preventing the television 100 from being possibly shaken in a front-back direction when, for instance, an earthquake occurs.

The guide slots 17 of the present embodiment are each preferably in the shape of the character “<” or “>”. With this structure, even in the case where after the television 100 is attached, force has been applied to the television 100 from below in such a direction as to push up the television 100 as a result of, for example, an accidental human contact or earthquake, the guide slots 17 limit an upward slide of the locking pins 30. In the case where force has been applied to the television 100 toward a side surface thereof or from its lower right, the guide slots 17 similarly limit a slide of the locking pins 30. Further, in the case where the guide slots 17 are each in the shape of the character “<” as illustrated in (a) of FIG. 4, even if force has been applied to the television 100 from its lower left, the guide slot upper portion 17a prevents a locking pin 30 from becoming disengaged from the guide slot 17, thereby preventing the locking pins 30 from becoming disengaged from the bracket 10.

The above structure can further prevent a locking pin 30 from abruptly dropping to a lower portion of the guide slot 17 when the television 100 is being attached.

Since the locking pins 30 each include a rotary section 36, the locking pins 30 are, when fitted in the bracket 10, each moved along a guide slot 17 as its rotary section 36 rotates. This arrangement allows the television 100 to be attached to the wall surface 50 with no extra force needed.

The above description for the present embodiment deals with an auxiliary bracket 20 as a member for fixing a lower portion of the television 100. The member for fixing a lower portion of the television 100 is, however, not limited to the auxiliary bracket 20, and may alternatively be a hook and loop fastener such as Velcro (registered trademark).

In other words, the attachment system of the present embodiment preferably further includes an auxiliary tool, such as the auxiliary bracket 20, for supporting the television 100 to prevent a shake of the television 100.

The above arrangement can prevent a lower portion of the television 100 from being shaken as a result of a possible shake caused to the television 100 in a front-back direction when, for instance, an earthquake occurs.

The bracket 10 may have a plurality of guide slots 17, and preferably have two guide slots 17. The inventors of the present invention have found that two guide slots 17 alone can still achieve the strength necessary to fix the television 100 to the wall surface 50. The inventors of the present invention have also found that attaching the television 100 to the wall surface 50 at only a few points as above can reduce damage to the wall surface 50 in comparison to the case of attaching the television 100 to the wall surface 50 at many points. Thus, when the television 100 is attached to the wall surface 50, the bracket 10 can, even with use of only two guide slots 17, prevent the television 100 from being detached from the wall surface 50.

In addition, the above attachment system can provide an attachment system with reduced weight.

(Method for Attaching Bracket 10 and Auxiliary Bracket 20 to Wall Surface 50)

With reference to FIG. 13, the description below deals with a method for attaching the bracket 10 and the auxiliary bracket 20 to a wall surface 50. FIG. 13 is a diagram illustrating an example paper pattern for use in attaching the bracket 10 and the auxiliary bracket 20 to a wall surface 50.

FIG. 13 illustrates a paper pattern for use in attaching a 32-inch television to a wall surface 50. FIG. 13 shows a double line that encloses an area that is equal in size to the television 100 (32 inches). A user affixes the paper pattern to a wall surface 50 at such a position that the area of the paper pattern which area is enclosed by the double line coincides with an area to which the user wants to attach the television 100.

FIG. 13 shows dotted lines that enclose (i) an area indicative of a position to which the bracket 10 is to be attached and (ii) an area indicative of a position to which the auxiliary bracket 20 is to be attached. The area for the bracket 10 has a size equal to the actual size of the bracket 10, whereas the area for the auxiliary bracket 20 has a size equal to the actual size of the auxiliary bracket 20. The user marks the respective positions to which the bracket 10 and the auxiliary bracket 20 are to be attached, and removes the paper pattern from the wall surface 50.

The user then attaches the bracket 10 and the auxiliary bracket 20 to the respective marked positions.

Using a paper pattern as described above allows the bracket 10 and the auxiliary bracket 20 to be attached easily to respective positions at which the locking pins 30 and locking pin 40, which are threadedly engaged with the back surface of the television 100, are to be engaged respectively with the bracket 10 and the auxiliary bracket 20.

(Shake Prevention Measure)

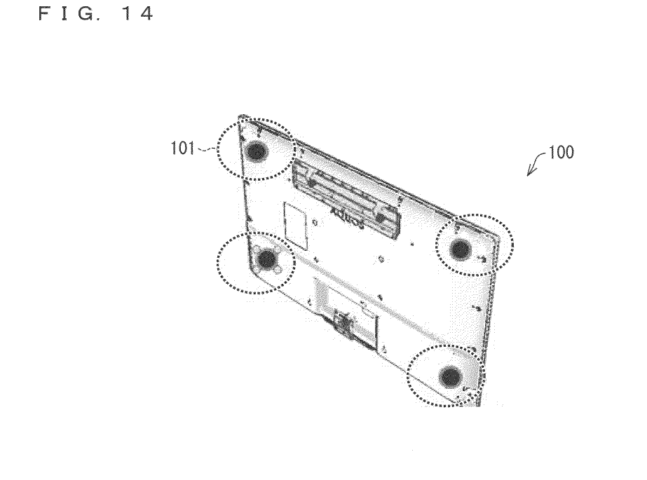

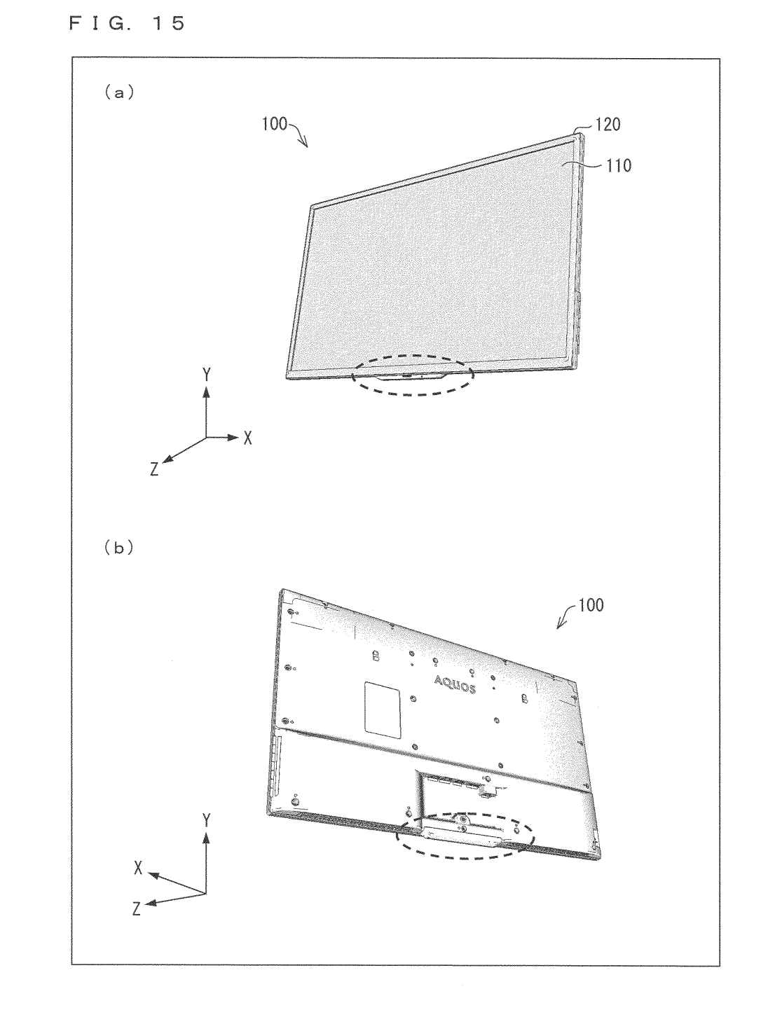

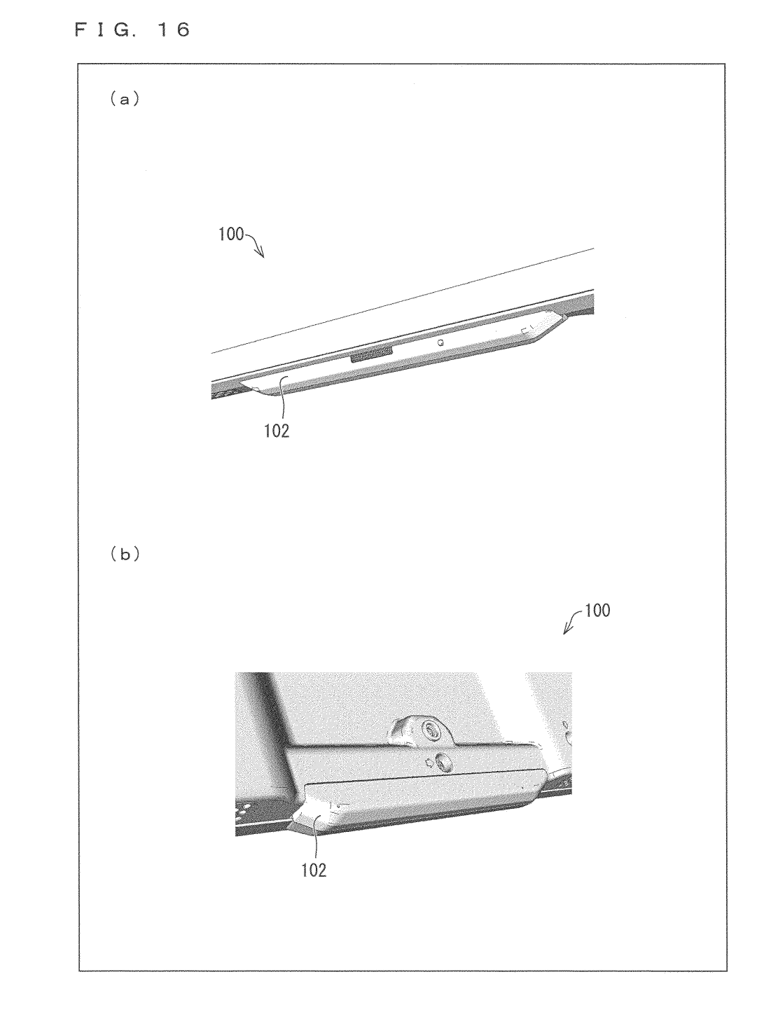

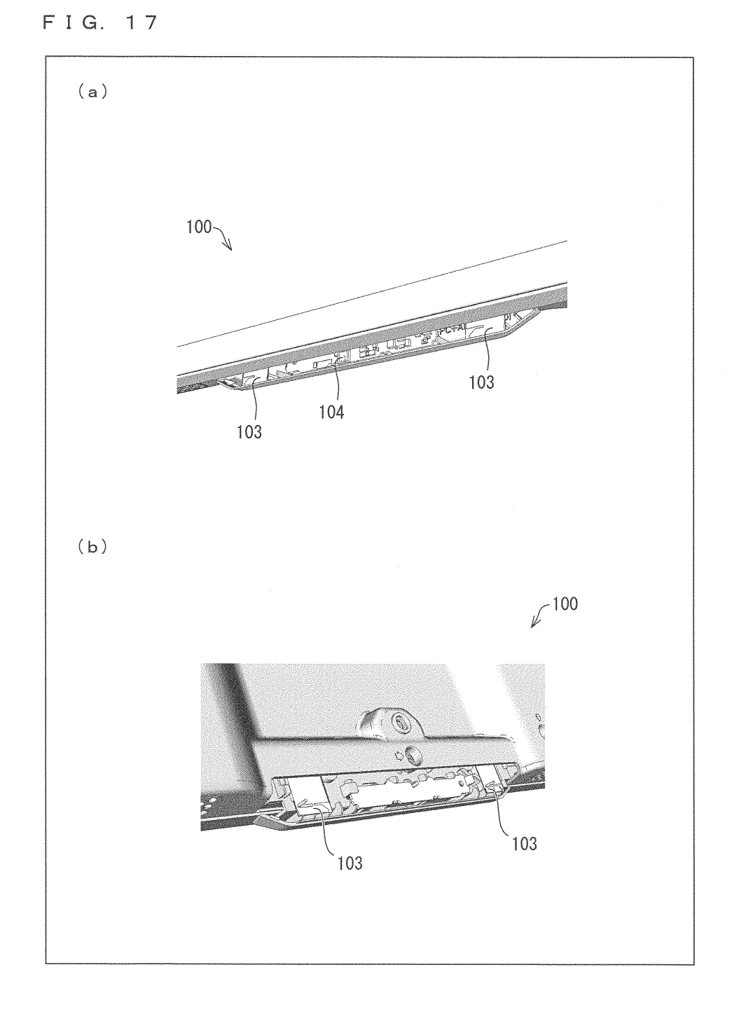

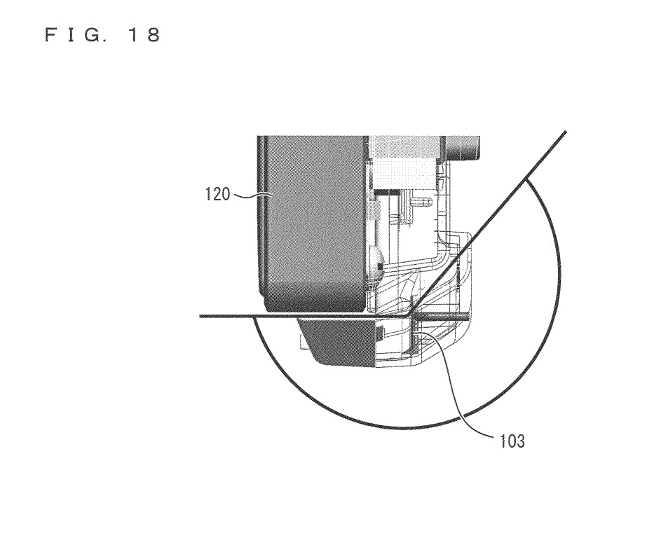

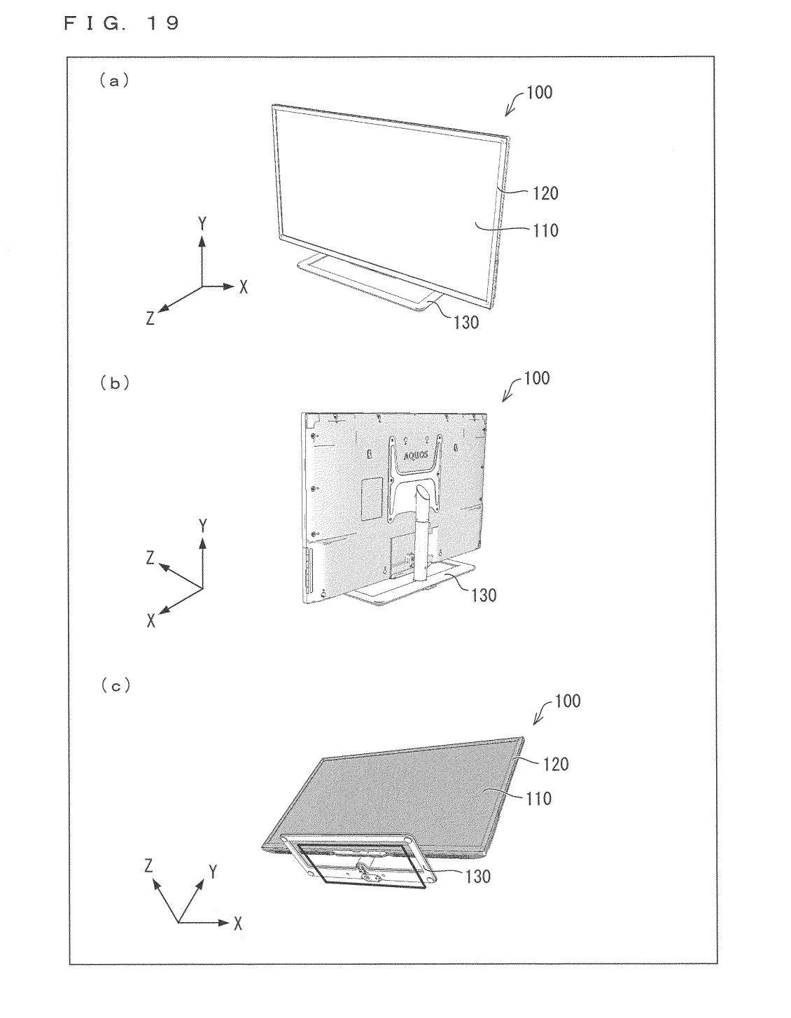

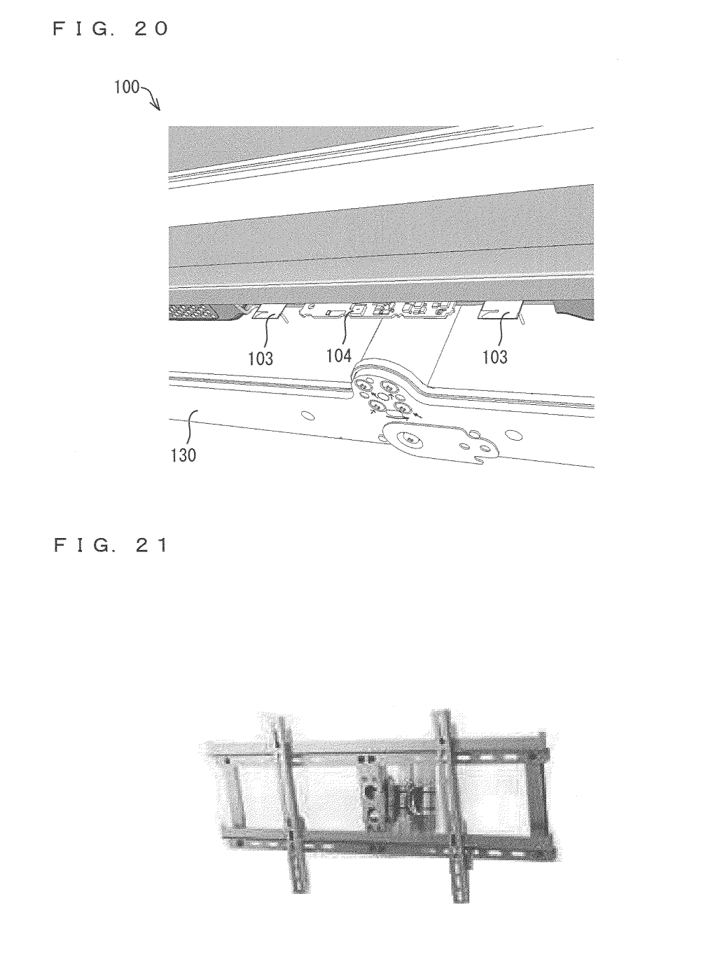

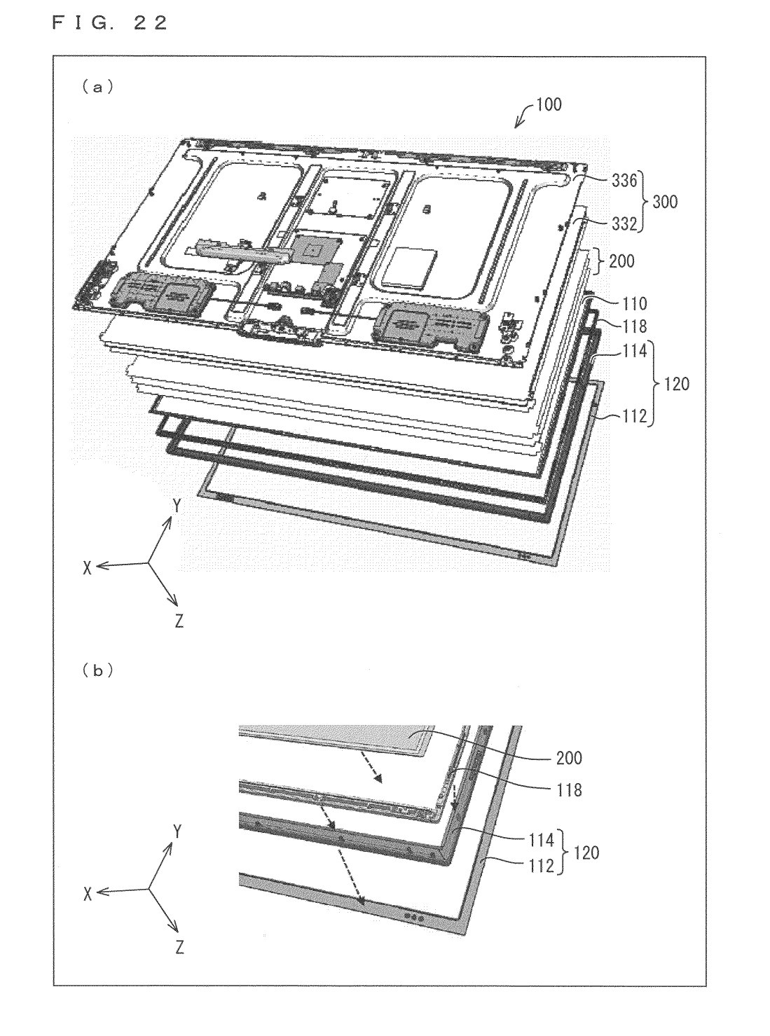

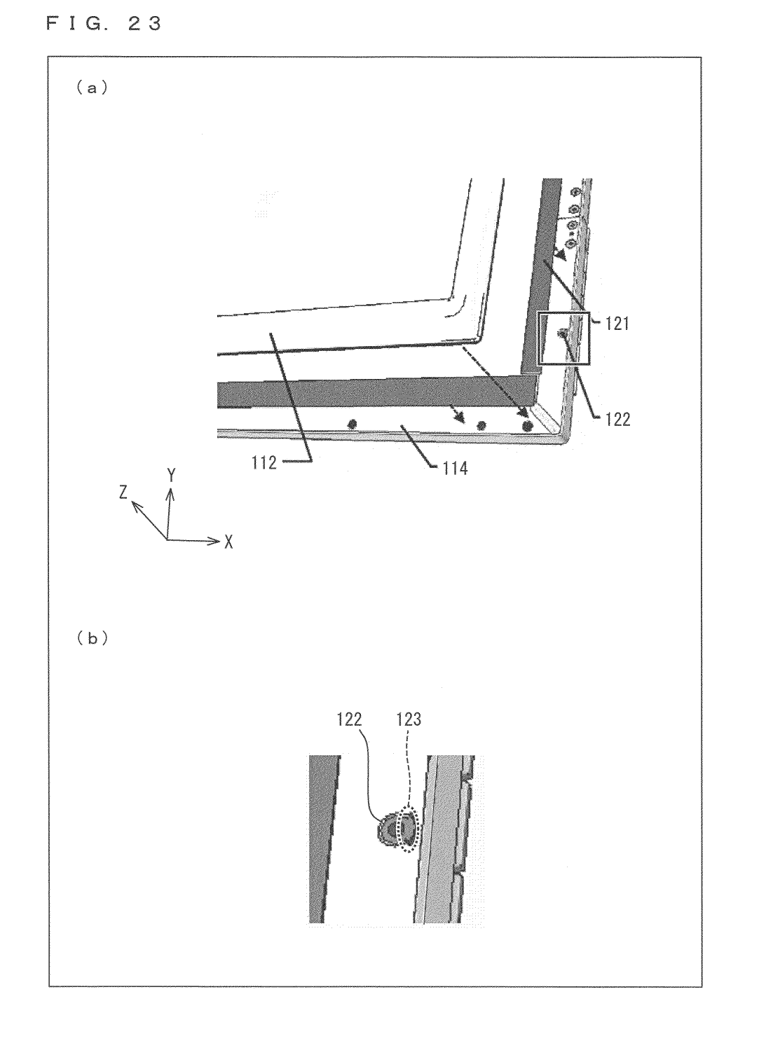

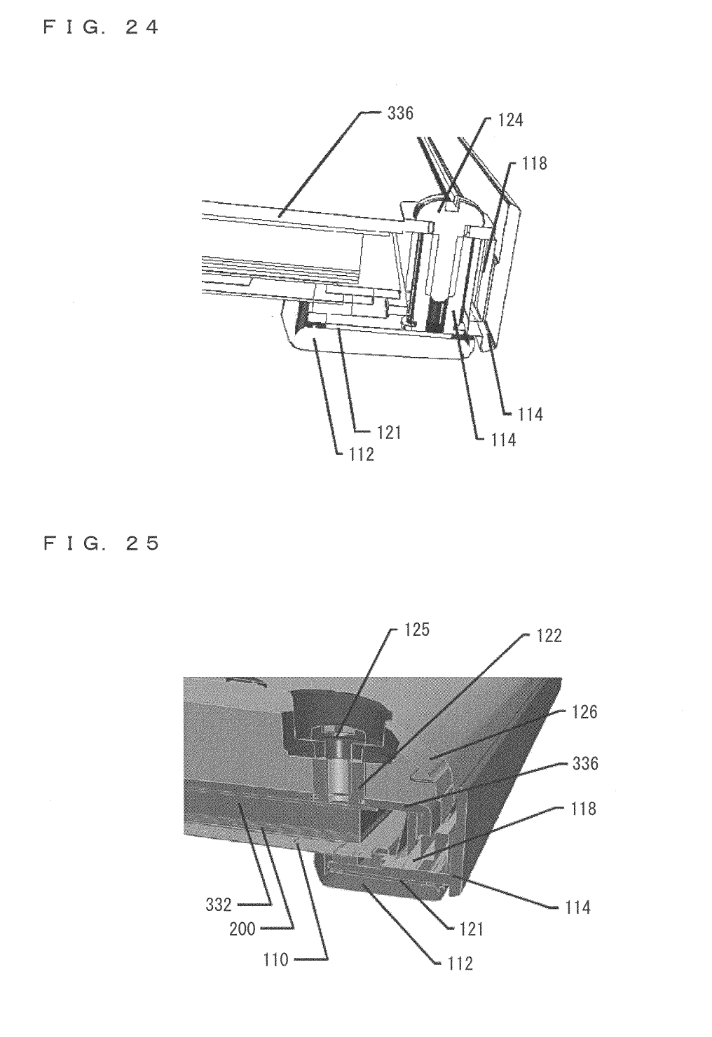

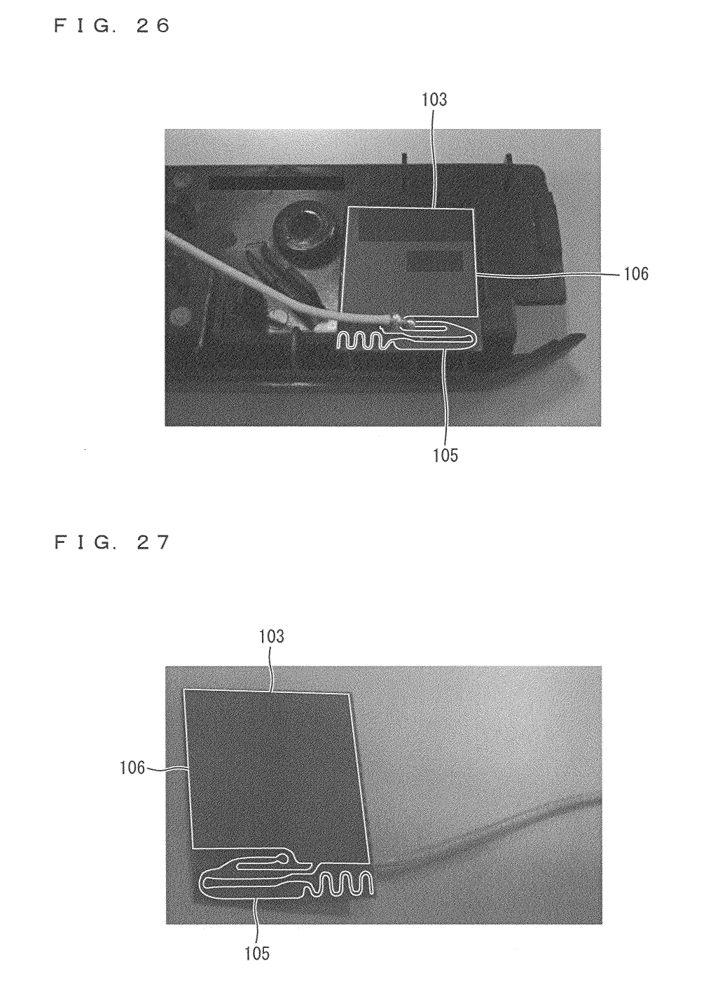

The description below deals with a further shake prevention measure with reference to FIG. 14. FIG. 14 is a perspective view of the television 100 as taken in a direction toward the back surface thereof.

The television 100 may be provided with rubber pads 101 on its back surface for shake prevention as illustrated in FIG. 14. The rubber pads are provided at the four corners of the back surface of the television 100. The respective positions of the rubber pads 101 are, however, not limited to the four corners.

The rubber pads 101 are each so formed as to have a thickness that is substantially equal to the distance by which the television 100 is to be separated from the wall surface 50 as the television 100 is attached to the attachment bracket 10. The rubber pads 101 are made of, for example, resin. The present embodiment is, however, not limited to such an arrangement.

The use of the above rubber pads 101 can prevent the television 100 from being shaken as separated from the wall surface 50.

(Television 100)

The description below deals with the television 100 with reference to FIGS. 15 through 20 and FIGS. 22 through 27. (a) of FIG. 15 is a perspective view of the television 100 as taken in a direction toward the frontal surface thereof. (b) of FIG. 15 is a perspective view of the television 100, the view being taken in a direction toward the back surface thereof. (a) of FIG. 16 is an enlarged view of a portion encircled by a dotted line in (a) of FIG. 15. (b) of FIG. 16 is an enlarged view of a portion encircled by a dotted line in (b) of FIG. 15. (a) of FIG. 17 is a view corresponding to (a) of FIG. 16 with a cover 102 detached. (b) of FIG. 17 is a view corresponding to (b) of FIG. 16 with the cover 102 detached.

The television 100, as illustrated in FIGS. 15 through 17, includes (i) antennas 103, (ii) an OPC/IR light receiving section 104, (iii) a display section 110 for displaying a video image, and (iv) an outer frame 120 surrounding the display section 110. The antennas 103 and the OPC/IR light receiving section 104 are provided at a portion of the television 100 which portion juts out downward from the outer frame 120 of the television 100 and which portion is covered by a lower cover 102. The rear surface of the display section 110 and the outer frame 120 are made of metal. The present embodiment is, however, not limited to such an arrangement.

The OPC/IR light receiving section 104 is a member for receiving a signal from, for example, a remote control.

The antennas 103 are each a member for carrying out a wireless telecommunication such as Wi-Fi (registered trademark). The antennas 103 each include an antenna element at a portion thereof that does not coincide with the outer frame 120 (that is, a portion that juts out downward from the outer frame 120). The antennas 103 each include a portion that coincides with the outer frame 120, at which portion the antenna 103 is fixed to the television 100. The portion of each antenna 103 which portion coincides with the outer frame 120 may be an antenna ground. The antennas 103 will be described further later.

The description below deals in detail with a configuration of main parts of the television (display device) 100 of the present embodiment with reference to FIGS. 22 through 25. FIG. 22 shows exploded perspective views each illustrating a configuration of main parts of a television 100 of one embodiment of the present invention. (a) of FIG. 22 is a perspective view of the television 100, the view being taken in a direction toward the back surface thereof, whereas (b) of FIG. 22 is an enlarged view corresponding to part of (a) of FIG. 22. FIG. 23 shows exploded perspective views each illustrating a configuration of main parts of a television 100 of one embodiment of the present invention. (a) of FIG. 23 is a perspective view of the television 100, the view being taken in a direction toward the frontal surface thereof, whereas (b) of FIG. 23 is an enlarged view corresponding to a portion enclosed by a line in (a) of FIG. 23.

The description below assumes that the forward direction side along the Z axis in FIGS. 22 through 25 corresponds to the frontal side of the television 100 (that is, the side toward which a video image is displayed; referred to also as “front surface side”) and that the backward direction side along the Z axis corresponds to the rear side of the television 100 (referred to also as “back surface side”).

The television 100 illustrated in (a) of FIG. 22 includes a tuner (not shown) and a display. The television 100 reproduces content received by the tuner and displays at the display a video image based on the content. This operation allows a user to view the content.

The television 100, as illustrated in (a) and (b) of FIG. 22, includes (i) an outer frame (frame section) 120, (ii) a display section (liquid crystal display panel) 110, (iii) a panel guide 118, (iv) an optical sheet set 200, and (v) a backlight unit 300. In actuality, the television 100 includes, in addition to the above members, a member such as a back surface cover for protecting the back surface of the television 100. Such additional members are, however, not illustrated in the drawings or described herein.

The outer frame 120, which surrounds the display section 110, includes a bezel 112 and a frame 114 as illustrated in (a) and (b) of FIG. 22.

The bezel 112 is attached to the frontal surface of the frame 114. The bezel 112 is provided to, for example, protect a surface of the frame 114 and improve the appearance of the television 100. Specifically, the bezel 112 is, as illustrated in (a) and (b) of FIG. 23, attached to the frontal surface of the frame 114, which is provided with fixing boss sections 122 and a double-sided adhesive tape 121.

The fixing boss sections 122, as illustrated in (b) of FIG. 23, each have a notch section 123. The notch section 123 allows a boss to be located at an end of a peripheral edge. Further, the provision of the bezel 112 via the double-sided adhesive tape 121 can prevent internal light from leaking out through the notch sections 123. To prevent internal light from leaking out through the notch sections 123, a washer may be fitted with each boss from the rear side of the frame 114 to block the fixing boss sections 122 from the rear side.

The bezel 112 is made of a metal such as aluminum, but may be made of a nonmetal such as resin.

The frame 114 supports the display section 110. Specifically, the frame 114 includes a frame section that has, on its frontal surface, an opening section corresponding in size to a display region of the display section 110. The frame section supports a peripheral edge section of the display section 110 (that is, a portion of the display section 110 which portion is located outside the display region). The frame 114 is made of a metal such as aluminum.

The display section 110 includes members such as (i) a TFT (thin film transistor) substrate, (ii) a color filter, and (iii) a polarizing filter. The TFT substrate includes, on a glass substrate, a plurality of TFT liquid crystal pixels connected to grid-shaped matrix wiring including gate lines and source lines. The display section 110 operates with use of a display driving circuit (not shown) to write to each TFT liquid crystal pixel a data signal corresponding to a video signal. This operation adjusts the amount of transmittance of backlight at each TFT liquid crystal pixel of the display section 110, and consequently allows a video image corresponding to a video signal to be displayed.

The panel guide 118 is, as illustrated in (b) of FIG. 22, fitted with the rear side of the frame 114. The panel guide 118 supports the display section 110 so that the display section 110 is fixed at a predetermined position inside the frame 114. The panel guide 118 is made of a nonmetal such as resin.

The optical sheet set 200 is so provided as to be sandwiched between the display section 110 and a backlight panel 332. The optical sheet set 200 is provided so as to adjust a property of backlight entering the display section 110. The optical sheet set 200 includes, for example, a plurality of sheet-shaped optical members such as a diffusing plate, a diffusing sheet, a lens sheet, and a polarizing/reflecting sheet.

The backlight unit 300 is so provided on the back surface side of the display section 110 as to emit backlight to the display section 110. Specifically, the backlight unit 300 includes (i) a backlight panel 332, (ii) an LED substrate 334 (not shown), and (iii) a backlight chassis 336.

The backlight panel 332 is provided on the back surface side of the display section 110. The backlight panel 332 is a so-called light guide plate that guides backlight (which has entered it from its side) to the display section 110.

The backlight chassis 336 supports the backlight panel 332 from a back surface side of the backlight panel 332. The backlight chassis 336 is made of a metal such as aluminum.

The LED substrate 334 includes (i) an LED array 335 (not shown) as a light source and (ii) an LED driving circuit (not shown) for driving the LED array 335. The LED substrate 334 is so provided at a side of the backlight panel 332 as to emit backlight into the backlight panel 332 from that side. The present embodiment is arranged such that the LED substrate 334 is provided at a lower side of the backlight panel 332 (that is, the backward direction side along the Y axis in FIGS. 22 through 25). The present embodiment is, however, not limited to such an arrangement.

FIG. 24 is a cross-sectional view of a portion of a television 100 of one embodiment of the present invention to which portion the frame 114 is fixed. FIG. 25 is a cross-sectional view of a portion of a television 100 of one embodiment of the present invention to which portion a back surface cover is fixed.

The frame 114 is fixed to the backlight chassis 336 by means of screws 124 as illustrated in FIG. 24. The back surface cover 126 is fixed to the backlight chassis 336 by means of screws 125 as illustrated in FIG. 25.

Integrating the frame 114 as described above with inside modules such as the display section 110, the panel guide 118, the sheet set 200, and the backlight unit 300 allows the television 100 to have a narrow picture frame. The integration of the inner modules and the frame 114 further allows the television 100 to be thin. In addition, the above configuration can not only eliminate the need to include a separate member to serve as the frame 114, but also reduce the number of parts in comparison to the structure of a conventional television including inner modules and a frame each as an independent unit. The above configuration consequently allows the television 100 to have reduced weight.

(Antennas 103)

The description below deals with the antennas 103 with reference to FIGS. 17, 26, and 27. FIG. 26 is a view of an antenna 103 disposed in the television 100, the view being taken in a direction toward the display section 110 of the television 100. FIG. 27 is a view of an antenna 103, the view being taken in a direction toward the rear surface of an antenna 103 in FIG. 26.

The antennas 103 are each a planar antenna as illustrated in (a) and (b) of FIG. 17. The antennas 103 are provided in the number of two on the lower side, along the vertical direction, of the display section 110 as the television 100 is placed upright. The number of the antennas 103 is, however, not limited to two, and may be one (1) or more than two. The plurality of antennas 103 disposed in the television 100 function as a diversity antenna as illustrated in (a) and (b) of FIG. 17. Constituting a diversity antenna as such can further increase the transmission capability.

The antennas 103 may be, as illustrated in (a) and (b) of FIG. 17, (i) so provided as to be close to the OPC/IR light receiving section (receiver circuit) 104, which is a member for receiving a signal from, for example, a remote control (that is, an external operation signal) or (ii) formed on the same substrate as the OPC/IR light receiving section 104 is formed.

When a user uses the television 100, an object is unlikely to be present on the frontal surface of the OPC/IR light receiving section 104 to block a signal from a remote control. This indicates that forming the antennas 103 and the receiver circuit on an identical substrate makes it unlikely that an object is present in the frontal direction of the television 100 from the antennas 103 to block a radio wave of the antennas 103. The above formation thus suitably prevents a decrease in the transmission capability of the antennas 103 with respect to the frontal direction of the television 100. The above formation can further reduce the number of parts necessary for the television 100, and consequently allows the television 100 to have reduced weight.

The antennas 103 each include an antenna element 105 and an antenna ground (ground section) 106 as illustrated in FIGS. 26 and 27. The antenna element 105 is so provided as to jut out from an outer edge of the outer frame 120 as illustrated in (a) and (b) of FIG. 17.

The antenna ground 106 is connected to the antenna element 105 as illustrated in FIGS. 26 and 27. The antenna ground 106 is, as illustrated in (a) and (b) of FIG. 17, provided at a portion that coincides with the outer frame 120. The antenna ground 106 is, in other words, disposed inside the outer frame 120. The disposition of the antenna ground 106 inside the outer frame 120 does not decrease the transmission capability of the antenna 103.

Disposing the antenna ground 106 as described above allows the picture frame to be narrow in comparison to the case where the entire antenna 103 is so provided as to jut out from the outer edge of the outer frame 120.

Disposing an antenna 103 inside the outer frame 120 necessitates dissipating heat to the outside of the television 100, which would in turn normally necessitate forming a hole for heat dissipation at a portion of the outer frame 120 at which portion the antenna 103 is disposed. Disposing the antennas 103 as in the present embodiment, however, allows heat generated by the antennas 103 to be released directly to the outside. The present embodiment thus eliminates the need to form holes in the outer frame 120 for heat dissipation. The present embodiment can consequently reduce costs that would otherwise be necessary to form such holes, and can prevent the strength of the outer frame 120 from being decreased by the holes. Further, forming no such holes improves formability and increases the degree of freedom in design. In addition, forming no such holes can prevent foreign matter from entering the television 100.

(Characteristics of Antenna 103)

FIG. 18 is a side view of the television 100, the view illustrating a general direction (beam direction) in which an antenna 103 emits a beam. The general beam direction of an antenna 103, as illustrated in FIG. 18, covers directions toward below and behind the television 100 with the antenna 103 as the center.

If an antenna 103 were disposed in its entirety at such a position on the display section 110 side of the television 100 as to coincide with the outer frame 120, the antenna 103 would have, for signal transmission, a beam direction having a range influenced by the display section 110 and the outer frame 120 to cover a space located in a forward direction of the television 100 with the antenna 103 as the center (that is, a space corresponding to about half of all directions). If an antenna 103 were disposed at such a position on the back surface side of the television 100 as to coincide with the outer frame 120, the antenna 103 would have, for signal transmission, a beam direction having a range influenced by the display section 110 and the outer frame 120 to cover a space located in a backward direction of the television 100 with the antenna 103 as the center (that is, a space corresponding to about half of all directions).

Disposing the antennas 103 as in the present embodiment, that is, so that the respective antenna elements 105 jut out from the outer edge of the outer frame 120, in contrast, allows the beam direction of the antennas 103 to have a range defined by the solid lines in FIG. 18. Disposing the antennas 103 as above thus increases the open space for the antennas and further reduces the limit on the beam direction of the antennas. Consequently, the above arrangement can, without increasing the thickness of the television 100 and while keeping its picture frame narrow, suitably prevent the transmission capability from decreasing depending on the incoming direction of radio waves.

The television 100, as it is placed on a wall surface 50, normally has a lower portion that is open to the outside. The above arrangement can thus make better use of the antenna characteristics when the television 100 is placed on a wall surface 50.

The antennas 103 are, as illustrated in (a) and (b) of FIG. 17, disposed below the display section 110 along the vertical direction as the television 100 is placed upright. For instance, the television 100, as it is placed on a wall surface 50, normally has a lower portion that is open to the outside. The above arrangement can thus make more suitable use of the antenna characteristics when the television 100 is placed on a wall surface 50.

With reference to FIGS. 19 and 20, the description below deals with a television 100 provided with a stationary placement stand 130. (a) of FIG. 19 is a perspective view of the television 100, the view being taken from above in a direction toward the frontal surface of the television 100. (b) of FIG. 19 is a perspective view of the television 100, the view being taken in a direction toward the back surface thereof. (c) of FIG. 19 is a perspective view of the television 100, the view being taken from below in a direction toward the frontal surface of the television 100. FIG. 20 is an enlarged view of a portion enclosed by a solid line in (c) of FIG. 19 with the cover 102 detached.

The stationary placement stand 130 is firmly fixed to the back surface of the television 100 as illustrated in FIG. 19. The stand 130 includes a portion serving as a base, the portion having an opening. The opening of the stand 130 can prevent the base portion of the stand 130 from being close to the antennas 103. The stand 130 is made of metal. The present embodiment is, however, not limited to such an arrangement.

If the stand 130 had no opening in its base portion, the antennas 103 would have a beam direction influenced by the stand 130 and thus limited with respect to directions toward below the television 100. The use of the stand 130 having an opening in its base portion, in contrast, prevents the antennas 103 from being blocked by the stand 130 and thus allows the antennas 103 to be open with respect to directions toward below the television 100 as illustrated in FIG. 20. Consequently, the use of the above stand 130, even in the case where the television 100 is placed at a stationary position, further reduces the limit on the beam direction of the antennas and suitably prevents the transmission capability from decreasing depending on the incoming direction of radio waves.

The television 100 described above can be viewed suitably by a user even in the case where, for instance, a tuner for the television 100 is placed downstairs from the television 100.

### Aspects of Present Invention

The present specification describes the invention below.

Television receivers (hereinafter referred to simply as “televisions”) have been produced with increasingly narrower picture frames and smaller thicknesses in recent years. There have been proposed techniques for providing an antenna for a television having such a narrow picture frame.

Patent Literature 2, for example, disclosed a wireless telecommunication device including (i) at a periphery section of a display screen, an antenna housing section provided with no electromagnetic shield and (ii) an antenna disposed at the antenna housing section.

A television with a narrow picture frame, however, problematically decreases the transmission sensitivity (transmission capability) of an antenna with respect to the frontal surface direction of the television. The technique of Patent Literature 2 requires increasing the picture frame width for the antenna housing section to be provided at a periphery section of a display device. Patent Literature 2 describes the wireless telecommunication device as including an antenna housing section having a plurality of through holes to increase the transmission sensitivity of the antenna. Such through holes, however, problematically decreases the strength of the periphery section of the display device.

The present specification describes the invention below for solving the above problems. It is an object of the invention below to provide a flat-screen display device with a narrow picture frame, the display device including an antenna having good transmission capability.

### Invention Aspect 1

A display device including: a frame section surrounding a display section; and at least one antenna for a wireless telecommunication, the at least one antenna including an antenna element provided so as to jut out from an outer edge of the frame section.

If the antenna were disposed in its entirety at such a position on the display section side of the display device as to coincide with the frame section, the antenna would have, for signal transmission, a beam direction having a range influenced by the display section and the frame section to cover a space located in a forward direction of the display device with the antenna as the center (that is, a space corresponding to about half of all directions). If the antenna were disposed at such a position on the back surface side of the display section as to coincide with the frame section, the antenna would have, for signal transmission, a beam direction having a range influenced by the display section and the frame section to cover a space located in a backward direction of the display device with the antenna as the center (that is, a space corresponding to about half of all directions).

Disposing the antenna as in the above arrangement, that is, so that the antenna element juts out from the outer edge of the frame section, in contrast, allows the beam direction of the antenna to have a range corresponding to a space from the forward direction of the display device to the backward direction of the display device. Disposing the antenna as above thus increases the open space for the antennas and further reduces the limit on the beam direction of the antennas. Consequently, the above arrangement can, without increasing the thickness of the display device and while keeping its picture frame narrow and the thickness small, suitably prevent the transmission capability from decreasing depending on the incoming direction of radio waves.

### Invention Aspect 2

The display device according to invention aspect 1, wherein: the at least one antenna is disposed below the display section along a vertical direction in a state where the display device is placed upright.

The display device, as it is placed on a wall surface, normally has a lower portion that is open to the outside. The above arrangement can thus make more suitable use of the antenna characteristics when the display device is placed on a wall surface.

### Invention Aspect 3

The display device according to invention aspect 1 or 2, wherein: the at least one antenna further includes a ground section connected to the antenna element; and the ground section is disposed at a position surrounded by the frame section.

Disposing the ground section as described above allows the picture frame to be narrow in comparison to the case where the entire antenna is so provided as to jut out from the outer edge of the frame section.

### Invention Aspect 4

The display device according to any one of invention aspects 1 to 3, wherein: the at least one antenna is a planar antenna.

The above arrangement allows the antenna to be provided without increasing the thickness of the display device.

### Invention Aspect 5

The display device according to any one of invention aspects 1 to 4, further including: a receiver circuit for receiving an external operation signal, the at least one antenna and the receiver circuit being provided on an identical substrate.

When a user uses the display device, an object is unlikely to be present on the frontal surface of the receiver circuit to block an external operation signal. This indicates that forming the antennas and the receiver circuit on an identical substrate makes it unlikely that an object is present in the frontal direction of the display device from the antennas to block a radio wave of the antennas. The above formation thus suitably prevents a decrease in the transmission capability of the antennas with respect to the frontal direction of the display device. The above formation can further reduce the number of parts necessary for the display device, and consequently allows the display device to have reduced weight.

### Invention Aspect 6

The display device according to any one of invention aspects 1 to 5, wherein: the at least one antenna includes a plurality of antennas provided for the display device; and the plurality of antennas function as a diversity antenna.

Constituting a diversity antenna as such can further increase the transmission capability.

### Invention Aspect 7

The display device according to invention aspect 6, wherein: the plurality of antennas include two antennas provided below the display section along a vertical direction in a state where the display device is placed upright.

Including two antennas as above further allows the display device to use a plurality of frequency bands. The above arrangement can thus increase the transmission capability further.

### Invention Aspect 8

A television receiver including:

a display device according to any one of invention aspects 1 to 7.

The above arrangement allows a television receiver to produce effects similar to those produced by the display device.

### Supplemental Notes

The present invention is not limited to the description of the embodiments above, but may be altered by a skilled person within the scope of the claims. An embodiment based on a proper combination of technical means disclosed in different embodiments is encompassed in the technical scope of the present invention.

### Preferable Embodiment of Present Invention

As described above, the present invention is a bracket for hanging a target object on a wall surface for attachment of the target object to the wall surface, the target object being provided with a pin attached to the target object, the bracket including: a back board section to be attached to the wall surface; and a front board section facing the back board section, the front board section having at least one guide slot extending from an upper end of the front board section in a downward direction, the back board section and the front board section being separated from each other by a clearance that is large at an upper portion and small at a lower portion so that a head section of the pin of which a neck section is fitted in the guide slot is sandwiched between the back board section and the front board section.

The bracket is structured such that the clearance between the back board section and the front board section is large at an upper portion and small at a lower portion. The head section of the pin inserted in the guide slot is, as the pin is moved downward along the guide slot, sandwiched between the back board section and the front board section to be fixed. With this arrangement, attaching a target object to a wall surface merely requires moving the pin, attached to the target object, downward along the guide slot. The above arrangement thus facilitates the attachment of a target object to a wall surface. Further, detaching a target object from a wall surface merely requires moving the target object upward along the guide slot. The above arrangement thus facilitates the detachment of a target object from a wall surface. After the attachment, the pin being sandwiched in the guide slot can prevent the target object and the wall surface from being possibly shaken relative to each other when, for instance, an earthquake occurs, thereby preventing the target object from being detached unexpectedly from the wall surface.

The bracket of the present invention may preferably be arranged such that the front board section has a surface facing the back board section which surface juts out at a lower portion toward the back board section so that the clearance between the back board section and the front board section is large at the upper portion and small at the lower portion.

With the above arrangement, the front board section has a surface facing the back board section which surface juts out at a lower portion toward the back board section. The above arrangement thus allows the target object to be fixed closely to the wall surface, and can more reliably prevent the target object and the wall surface from being possibly shaken relative to each other when, for instance, an earthquake occurs.

The bracket of the present invention may preferably be arranged such that the at least one guide slot includes two guide slots.

With the above arrangement, the front board section has two guide slots. The above arrangement thus allows the target object to be fixed to the wall surface at at least two points, and can more reliably prevent the target object and the wall surface from being possibly shaken relative to each other when, for instance, an earthquake occurs.

The bracket of the present invention may preferably be arranged such that the at least one guide slot is bent.

With the above arrangement, the guide slot is bent. The above arrangement thus prevents the target object from becoming disengaged from the bracket even if a linear shake occurs between the target object and the wall surface when, for instance, an earthquake occurs. The above arrangement consequently allows the target object to be more reliably attached to the wall surface.

The bracket of the present invention may preferably be arranged such that the at least one guide slot is bent in a shape of a character “<” or “>”.

With the above arrangement, the guide slot is bent in the shape of the character “<” or “>”. The above arrangement thus allows the target object to be easily and reliably attached to the wall surface.

With the above arrangement, even in the case where after the target object is attached, force has been applied to the target object from below in such a direction as to push up the target object as a result of, for example, an accidental human contact or earthquake, the guide slot limits an upward slide of the pins. In the case where force has been applied to the target object obliquely from below so that the pin is moved along the guide slot lower portion in the shape of the character “<”, the pin is not moved to an upper portion of the guide slot because of the bent of the guide slot.

The above arrangement can, as described above, prevent the target object from becoming disengaged from the bracket.

The above arrangement can further prevent the pin from abruptly dropping to a lower portion of the guide slot when the target object is being attached.

The bracket of the present invention may preferably be arranged such that the target object is a television receiver.

The above arrangement allows a television receiver to be reliably attached to the wall surface.

An attachment system of the present invention includes: the bracket; and the pin.

The attachment system produces effects similar to those produced by the above bracket.

The attachment system of the present invention may preferably further include: an auxiliary bracket to be attached to the wall surface together with the bracket so as to support the target object to prevent a shake of the target object.

The above arrangement allows the target object to be reliably attached to the wall surface with use of the auxiliary bracket so that the target object will not be shaken. Stated differently, the above arrangement can prevent a lower portion of the target object from being shaken in a direction perpendicular to the wall surface as a result of a possible shake caused to the target object in a front-back direction when, for instance, an earthquake occurs.

The attachment system of the present invention may preferably be arranged such that the neck section of the pin includes a cylindrical section and a rotary slider fitted with the cylindrical section inserted therein.

With the above arrangement, the neck section of the pin includes a cylindrical section and a rotary slider fitted with the cylindrical section inserted therein. Thus, when the target object is being attached to the wall surface, the pin is moved smoothly along the guide slot.

The above arrangement consequently allows the target object to be easily attached to the wall surface.

A wallpaper of the present invention is a wallpaper for attaching, to a wall surface, the bracket and the auxiliary bracket both included in the attachment system, the wallpaper showing an attachment area for the bracket and an attachment area for the auxiliary bracket, the attachment area for the bracket being equal in size to the bracket, the attachment area for the auxiliary bracket being equal in size to the auxiliary bracket.

The wallpaper shows an attachment area for the bracket and an attachment area for the auxiliary bracket, the attachment area for the bracket being equal in size to the bracket, the attachment area for the auxiliary bracket being equal in size to the auxiliary bracket. The wallpaper thus allows the bracket and the auxiliary bracket to be easily attached to the wall surface.

A display device of the present invention is a display device including: a frame section surrounding a display section; and at least one antenna for a wireless telecommunication, the at least one antenna including an antenna element provided so as to jut out from an outer edge of the frame section.

If the antenna were disposed in its entirety at such a position on the display section side of the display device as to coincide with the frame section, the antenna would have, for signal transmission, a beam direction having a range influenced by the display section and the frame section to cover a space located in a forward direction of the display device with the antenna as the center (that is, a space corresponding to about half of all directions). If the antenna were disposed at such a position on the back surface side of the display section as to coincide with the frame section, the antenna would have, for signal transmission, a beam direction having a range influenced by the display section and the frame section to cover a space located in a backward direction of the display device with the antenna as the center (that is, a space corresponding to about half of all directions).

Disposing the antenna as in the above arrangement, that is, so that the antenna element juts out from the outer edge of the frame section, in contrast, allows the beam direction of the antenna to have a range corresponding to a space from the forward direction of the display device to the backward direction of the display device. Disposing the antenna as above thus increases the open space for the antennas and further reduces the limit on the beam direction of the antennas. Consequently, the above arrangement can, without increasing the thickness of the display device and while keeping its picture frame narrow and the thickness small, suitably prevent the transmission capability from decreasing depending on the incoming direction of radio waves.

The display device of the present invention may preferably be arranged such that the at least one antenna is disposed below the display section along a vertical direction in a state where the display device is placed upright.

The display device, as it is placed on a wall surface, normally has a lower portion that is open to the outside. The above arrangement can thus make more suitable use of the antenna characteristics when the display device is placed on a wall surface.

The display device of the present invention may preferably be arranged such that the at least one antenna further includes a ground section connected to the antenna element; and the ground section is disposed at a position surrounded by the frame section.

Disposing the ground section as described above allows the picture frame to be narrow in comparison to the case where the entire antenna is so provided as to jut out from the outer edge of the outer edge.

The display device of the present invention may preferably be arranged such that the at least one antenna is a planar antenna.

The above arrangement allows the antenna to be provided without increasing the thickness of the display device.

The display device of the present invention may further include: a receiver circuit for receiving an external operation signal, the at least one antenna and the receiver circuit being provided on an identical substrate.

When a user uses the display device, an object is unlikely to be present on the frontal surface of the receiver circuit to block an external operation signal. This indicates that forming the antennas and the receiver circuit on an identical substrate makes it unlikely that an object is present in the frontal direction of the display device from the antennas to block a radio wave of the antennas. The above formation thus suitably prevents a decrease in the transmission capability of the antennas with respect to the frontal direction of the display device. The above formation can further reduce the number of parts necessary for the display device, and consequently allows the display device to have reduced weight.

The display device of the present invention may be arranged such that the at least one antenna includes a plurality of antennas provided for the display device; and the plurality of antennas function as a diversity antenna. The display device of the present invention may be arranged such that the plurality of antennas include two antennas provided below the display section along a vertical direction in a state where the display device is placed upright.

Constituting a diversity antenna as such can further increase the transmission capability.

The present invention includes in its scope a television receiver including the display device.

### INDUSTRIAL APPLICABILITY

The present invention is suitably applicable to the field of production of attachment systems such as a metal fitting for attachment of a television receiver.

### REFERENCE SIGNS LIST

10 bracket
11 back board section
11a upper fringe
11b lower fringe
13 upper board section
14 front board section
15 lower board section
16 opening section
17 guide slot
17a guide slot upper portion
17b guide slot lower portion
18 through hole
19 void
20 auxiliary bracket
21 back board section
22 rail groove
23 opening section
24 entry section
28 through hole
30 locking pin
31 head section
32 cylindrical section
33 neck section
34 shaft section
35 chamfer section
36 rotary section (rotary slider)
37 spring washer
40 locking pin
41 head section
42 cylindrical section
43 shaft section
50 wall surface
100 television (target object, display device)
101 rubber pad
102 cover
103 antenna
104 OPC/IR light receiving section
105 antenna element
106 antenna ground (ground section)
110 display section (liquid crystal display panel)
120 outer frame
130 stand
112 bezel
114 frame
118 panel guide
121 double-sided adhesive tape
122 fixing boss section
123 notch section
124 screw
125 screw
126 back surface cover
200 sheet set
300 backlight unit
332 backlight panel
334 LED substrate
335 LED array
336 backlight chassis (chassis)

1.-18. (canceled)

19. A bracket for hanging a target object on a wall surface for attachment of the target object to the wall surface, the target object being provided with a pin attached to the target object,
the bracket comprising:
a back board section to be attached to the wall surface; and
a front board section facing the back board section,
the front board section having at least one guide slot extending from an upper end of the front board section in a downward direction,
the back board section and the front board section being separated from each other by a clearance that is large at an upper portion and small at a lower portion so that a head section of the pin of which a neck section is fitted in the at least one guide slot is sandwiched between the back board section and the front board section.

20. The bracket according to claim 19,
wherein:
the front board section has a surface facing the back board section which surface juts out at a lower portion toward the back board section so that the clearance between the back board section and the front board section is large at the upper portion and small at the lower portion.

21. The bracket according to claim 19,
wherein:
the at least one guide slot includes two guide slots.

22. The bracket according to claim 19,
wherein:
the at least one guide slot is bent.

23. The bracket according to claim 22,
wherein:
the at least one guide slot is bent in a shape of a character “<” or “>”.

24. The bracket according to claim 19,
wherein:
the target object is a television receiver.

25. An attachment system comprising:
a bracket according to claim 19; and
the pin.

26. The attachment system according to claim 25, further comprising:
an auxiliary bracket to be attached to the wall surface together with the bracket so as to support the target object to prevent a shake of the target object.

27. The attachment system according to claim 25,
wherein:
the neck section of the pin includes a cylindrical section and a rotary slider fitted with the cylindrical section inserted therein.

28. A paper pattern for attaching, to a wall surface, the bracket and the auxiliary bracket both included in the attachment system according to claim 26,
the paper pattern showing an attachment area for the bracket and an attachment area for the auxiliary bracket,
the attachment area for the bracket being equal in size to the bracket,
the attachment area for the auxiliary bracket being equal in size to the auxiliary bracket.
